(19) United States
(12) Patent Application Publication
(10) Pub. No.: US 2024/0300139 A1
(43) Pub. Date: Sep. 12, 2024

(54) METHODS OF MAKING ARTICLES INCLUDING INKJET PRINTING SOLS CONTAINING METAL OXIDE NANOPARTICLES

(71) Applicant: 3M INNOVATIVE PROPERTIES COMPANY, Saint Paul, MN (US)

(72) Inventors: Malte KORTEN, Moorenwels (DE); Martin GOETZINGER, Vilgertshofen (DE); Michael JAHNS, Gilching (DE); Gareth A. HUGHES, St. Paul, MN (US); Melissa A. LACKEY, Woodbury, MN (US); Jeffrey N. BARTOW, St. Paul, MN (US)

(21) Appl. No.: 18/258,839

(22) PCT Filed: Nov. 17, 2021
(86) PCT No.: PCT/IB2021/060673

§ 371 Date: Jun. 22, 2023

Related U.S. Application Data
(60) Provisional application No. 63/129,707, filed on Dec. 23, 2020.

(51) Int. Cl. B28B 1/00; B28B 17/00; B33Y 10/00; B33Y 50/02; B33Y 70/00

(52) U.S. Cl. CPC B28B 1/001; B28B 17/0081; B33Y 10/00; B33Y 50/02; B33Y 70/00

(57) ABSTRACT

The present disclosure provides a method of making a three-dimensional article. The method includes a) inkjetting a sol through a nozzle having a diameter of 10 to 70 micrometers to form droplets of printed sol; b) solidifying the printed sol to form a portion of the three-dimensional article; and c) repeating steps a) and b) to form the three-dimensional article having a specified geometry. The sol includes i) 5 to 40 percent by volume of metal oxide particles, based on the total volume of the sol; ii) a solvent; iii) a surface modifying agent; and iv) optionally a polymerizable component. The metal oxide particles have an average particle size of 20 nanometers or less and of 1/100 to 1/10,000 of a diameter of the nozzle. The method enables high resolution additive manufacturing of an object having differences in one or more optical or mechanical property over a small area or volume of the object.

### FIELD

The present disclosure generally relates to additive manufacturing articles by inkjet printing of sols.

### SUMMARY

The present disclosure provides a method of making a three-dimensional article. The method comprises: a) inkjetting a sol through a nozzle having a diameter of 10 micrometers to 70 micrometers to form a plurality of droplets of printed sol; b) solidifying the printed sol to form a portion of the three-dimensional article; and c) repeating steps a) and b) to form the three-dimensional article having a specified geometry. The sol includes: i) 5 percent by volume (vol. %) to 40 vol. % of metal oxide particles, based on the total volume of the sol, the metal oxide particles having an average particle size of 20 nanometers (nm) or less and of 1/100 to 1/10,000 of a diameter of the nozzle; ii) a solvent; iii) a surface modifying agent; and iv) optionally a polymerizable component.

The method enables fine resolution additive manufacturing of an object having differences in one or more optical or mechanical property over a small area or volume of the object.

The above summary of the present disclosure is not intended to describe each disclosed embodiment or every implementation of the present disclosure. The description that follows more particularly exemplifies illustrative embodiments. In several places throughout the application, guidance is provided through lists of examples, which examples can be used in various combinations. In each instance, the recited list serves only as a representative group and should not be interpreted as an exclusive list.

### BRIEF DESCRIPTION OF DRAWINGS

FIG. 1 is a generalized process flow diagram of a method of making a three-dimensional article according to the present disclosure.

FIG. 2 is a generalized process flow diagram of a workflow for a method according to the present disclosure.

FIG. 3 is a block diagram of a generalized system for additive manufacturing of an article.

FIG. 4 is a block diagram of a generalized manufacturing process for an article.

FIG. 5 is a high-level flow chart of an exemplary article manufacturing process.

FIG. 6 is a high-level flow chart of an exemplary article additive manufacturing process.

FIG. 7 is a schematic front view of an exemplary computing device.

FIG. 8 is a photograph of an exemplary three-dimensional article according to the present disclosure.

Repeated use of reference characters in the specification and drawings is intended to represent the same or analogous features or elements of the disclosure. It should be understood that numerous other modifications and embodiments can be devised by those skilled in the art, which fall within the scope and spirit of the principles of the disclosure. The figures may not be drawn to scale.

### DETAILED DESCRIPTION

The words “preferred” and “preferably” refer to embodiments of the disclosure that may afford certain benefits, under certain circumstances. However, other embodiments may also be preferred, under the same or other circumstances. Furthermore, the recitation of one or more preferred embodiments does not imply that other embodiments are not useful, and is not intended to exclude other embodiments from the scope of the disclosure.

In this application, terms such as “a”, “an”, and “the” are not intended to refer to only a singular entity, but include the general class of which a specific example may be used for illustration. The terms “a”, “an”, and “the” are used interchangeably with the term “at least one.” The phrases “at least one of” and “comprises at least one of” followed by a list refers to any one of the items in the list and any combination of two or more items in the list.

As used herein, the term “or” is generally employed in its usual sense including “and/or” unless the content clearly dictates otherwise.

The term “and/or” means one or all of the listed elements or a combination of any two or more of the listed elements.

Also, herein, all numbers are assumed to be modified by the term “about” and preferably by the term “exactly.” As used herein in connection with a measured quantity, the term “about” refers to that variation in the measured quantity as would be expected by the skilled artisan making the measurement and exercising a level of care commensurate with the objective of the measurement and the precision of the measuring equipment used. Also, herein, the recitations of numerical ranges by endpoints include all numbers subsumed within that range as well as the endpoints (e.g., 1 to 5 includes 1, 1.5, 2, 2.75, 3, 3.80, 4, 5, etc.).

As used herein as a modifier to a property or attribute, the term “generally”, unless otherwise specifically defined, means that the property or attribute would be readily recognizable by a person of ordinary skill but without requiring absolute precision or a perfect match (e.g., within +/−20% for quantifiable properties). The term “substantially”, unless otherwise specifically defined, means to a high degree of approximation (e.g., within +/−10% for quantifiable properties) but again without requiring absolute precision or a perfect match. Terms such as same, equal, uniform, constant, strictly, and the like, are understood to be within the usual tolerances or measuring error applicable to the particular circumstance rather than requiring absolute precision or a perfect match.

As used herein, “aliphatic group” means a saturated or unsaturated linear, branched, or cyclic hydrocarbon group. This term is used to encompass alkyl, alkenyl, and alkynyl groups, for example.

As used herein, “alkyl” means a linear or branched, cyclic or acyclic, saturated monovalent hydrocarbon having from one to thirty-two carbon atoms, e.g., methyl, ethyl, 1-propyl, 2-propyl, pentyl, and the like.

As used herein, “alkylene” means a linear saturated divalent hydrocarbon having from one to twelve carbon atoms or a branched or cyclic saturated divalent hydrocarbon radical having from two to twelve carbon atoms, e.g., methylene, ethylene, propylene, 2-methylpropylene, pentylene, hexylene, and the like.

As used herein, each of “alkenyl” and “ene” refers to a monovalent linear or branched unsaturated aliphatic group with one or more carbon-carbon double bonds, e.g., vinyl.

As used herein, the term “arylene” refers to a divalent group that is carbocyclic and aromatic. The group has one to five rings that are connected, fused, or combinations thereof. The other rings can be aromatic, non-aromatic, or combinations thereof. In some embodiments, the arylene group has up to 5 rings, up to 4 rings, up to 3 rings, up to 2 rings, or one aromatic ring.

For example, the arylene group can be phenylene.

As used herein, the term “hardenable” refers to a material that can be cured or solidified, e.g., by heating to remove solvent, heating to cause polymerization, chemical crosslinking, radiation-induced polymerization or crosslinking, or the like.

As used herein, “curing” means the hardening or partial hardening of a composition by any mechanism, e.g., by heat, light, radiation, e-beam, microwave, chemical reaction, or combinations thereof.

As used herein, “cured” refers to a material or composition that has been hardened or partially hardened (e.g., polymerized or crosslinked) by curing. As used herein, “photocured” refers to a material or composition that has been hardened or partially hardened using actinic radiation.

As used herein, “liquid” refers to the state of matter that is not solid or gas, which has a definite volume and an indefinite shape. Liquids encompass sols, emulsions, dispersions, suspensions, solutions, and pure components, and exclude (e.g., solid) powders and particulates.

As used herein, the term “(meth)acrylate” is a shorthand reference to acrylate, methacrylate, or combinations thereof, “(meth)acrylic” is a shorthand reference to acrylic, methacrylic, or combinations thereof, and “(meth)acryl” is a shorthand reference to acryl and methacryl groups. “Acryl” refers to derivatives of acrylic acid, such as acrylates, methacrylates, acrylamides, and methacrylamides. By “(meth)acryl” is meant a monomer or oligomer having at least one acryl or methacryl group and linked by an aliphatic segment if containing two or more groups. As used herein, “(meth)acrylate-functional compounds” are compounds that include, among other things, a (meth)acrylate moiety.

As used herein, “ceramic” and “ceramic article” include amorphous material, glass, crystalline ceramic, glass-ceramic, and combinations thereof, and refers to non-metallic materials produced by application of heat. Ceramics are usually classified as inorganic materials. The term “amorphous material” refers to material that lacks long range crystal structure as determined by X-ray diffraction and/or has an exothermic peak corresponding to the crystallization of the amorphous material as determined by DTA (differential thermal analysis). The term “glass” refers to amorphous material exhibiting a glass transition temperature. The term “glass-ceramic” refers to ceramics comprising crystals formed by heat-treating amorphous material. The term “crystalline ceramic” refers to a ceramic material exhibiting a discernible X-ray powder diffraction pattern. “Crystalline” means a solid composed of atoms arranged in a pattern periodic in three dimensions (i.e., has long-range crystal structure, which may be determined by techniques such as X-ray diffraction). A “crystallite” means a crystalline domain of a solid having a defined crystal structure. A crystallite can only have one crystal phase. “Semicrystalline” means a material that comprises both an amorphous region and a crystalline region.

As used herein, “ceramic particle” encompasses particles of amorphous material, glass, crystalline ceramic, glass-ceramic, and combinations thereof, and refers to non-metallic materials produced by application of heat or made by a chemical synthesis process. Ceramic particles are usually classified as inorganic materials. The term “amorphous material” with respect to ceramic particles refers to a material derived from a melt and/or a vapor phase as well as a material made from chemical synthesis, wherein the material lacks long range crystal structure as determined by X-ray diffraction and/or has an exothermic peak corresponding to the crystallization of the amorphous material as determined by DTA (differential thermal analysis).

As used herein, a “dental article” means any article that can be or is to be used in the dental or orthodontic field, especially for producing of or as dental restoration, a tooth model and parts thereof. Examples of dental articles include crowns (including monolithic crowns), bridges, inlays, onlays, veneers, facings, copings, crown and bridged framework, implants, abutments, orthodontic appliances (e.g. brackets, buccal tubes, cleats and buttons) and parts thereof. The surface of a tooth is considered not to be a dental article.

As used herein, “particle” refers to a substance being a solid having a shape which can be geometrically determined. The shape can be regular or irregular. Particles can typically be analyzed with respect to, e.g., particle size and particle size distribution. A particle can comprise one or more crystallites. Thus, a particle can comprise one or more crystal phases.

The term “primary particle size” refers to the size of a non-associated single nanoparticle, which is considered to be a primary particle. X-ray diffraction (XRD) is typically used to measure the primary particle size of crystalline materials; transmission electron microscopy (TEM) is typically used to measure the primary particle size of amorphous materials.

As used herein, “sol” refers to a stable, continuous liquid phase containing discrete particles having sizes in a range from 1 nm to 100 nm or from 1 to 50 nm, a so-called “colloidal solution”. The sols described in the present text are translucent and do show a so-called “Tyndall effect” or “Tyndall scattering”. The size of the particles is below the wavelength of the visible light (400 to 750 nm).

As used herein, a “resin” contains all polymerizable components (monomers, oligomers and/or polymers) being present in a hardenable composition. The resin may contain only one polymerizable component compound or a mixture of different polymerizable compounds.

As used herein, “solvent” refers to a nonreactive liquid component of a composition that dissolves at least one solid component, or dilutes at least one liquid component, of the composition (in the case of water, adventitious amounts of water are not included by the term “solvent”).

As used herein, “solid” refers to a state of matter that is solid at one atmosphere of pressure and at least one temperature in the range of from 20-25° C., inclusive, (as opposed to being in a gaseous or liquid state of matter).

As used herein, “heat treating”, “calcining”, “binder burn out”, or “debindering” refers to a process of heating solid material to drive off at least 90 percent by weight of volatile chemically bound components (e.g., organic components) (versus, for example, drying, in which physically bonded water is driven off by heating). Heat treating is done at a temperature below a temperature needed to conduct a sintering step.

As used herein, “sintering” and “firing” are used interchangeably. A porous (e.g., pre-sintered) ceramic article shrinks during a sintering step, that is, if an adequate temperature is applied. The sintering temperature to be applied depends on the ceramic material chosen.

Sintering typically includes the densification of a porous material to a less porous material (or a material having fewer voids, pores, or cells) having a higher density; in some cases sintering may also include changes of the material phase composition (for example, a partial conversion of an amorphous phase toward a crystalline phase).

As used herein, “sintered article” refers to a gelled article that has been dried, heated to remove the organic matrix, and then further heated to reduce porosity and to densify. The density after sintering is at least 40 percent of the theoretical density. Articles having a density in a range of 40 to 93 percent of the theoretical density typically have open porosity (pores open to surface). Above 93 percent or 95 percent of the theoretical density, there are typically closed pores (no pores open to the surface).

As used herein, “density” means the ratio of mass to volume of an object. The unit of density is typically grams per cubic centimeter (g/cm³). The density of an object can be calculated e.g., by determining its volume (e.g., by calculation or applying the Archimedes principle or method) and measuring its mass. The volume of a sample can be determined based on the overall outer dimensions of the sample. The density of the sample can be calculated from the measured sample volume and the sample mass. The total volume of a material sample can be calculated from the mass of the sample and the density of the used material. The total volume of cells in the sample is assumed to be the remainder of the sample volume (100% minus the total volume of material).

As used herein, “theoretical density” refers to the maximum possible density that would be obtained in a sintered article if all pores were removed. The percent of the theoretical density for a sintered article can be determined, for example, from electron micrographs of a cross-section of the sintered article. The percent of the area of the sintered article in the electron micrograph that is attributable to pores can be calculated. Stated differently, the percent of the theoretical density can be calculated by subtracting the percent voids from 100 percent. That is, if 1 percent of the area of the electron micrograph of the sintered article is attributable to pores, the sintered article is considered to have a density equal to 99 percent of the theoretical density. The density can also be determined by the Archimedes method.

As used herein, “gel”, “gelled article”, and “gelled body” are used interchangeably and mean a three-dimensional gel resulting from the curing reaction of polymerizable components contained in a sol.

As used herein, “aerogel” means a three-dimensional low-density solid. An aerogel is a porous material derived from a gel, in which the liquid component of the gel has been replaced with a gas. The solvent removal is often done under supercritical conditions. During this process the network does not substantially shrink, and a highly porous, low-density material can be obtained.

As used herein, “xerogel” refers to a three-dimensional solid derived from a gel, in which the liquid component of the gel has been removed by evaporation under ambient conditions or at an elevated temperature.

As used herein, “green body” means an un-sintered ceramic item, typically having an organic binder (e.g., reaction product of polymerizable component) present.

As used herein, “white body” and “porous ceramic article” are interchangeable and refer to an item that has had the binder burned out or to a pre-sintered ceramic item.

As used herein, a “pre-sintered” ceramic item is an item that has had solvent and binder removed and exhibits a density of lower than 93% of its theoretical density.

As used herein, “geometrically defined article” means an article the shape of which can be described with geometrical terms including 2-dimensional terms like circle, square, rectangle, and 3-dimensional terms like layer, cube, cuboid, sphere.

As used herein, “isotropic linear sintering behavior” means that the sintering of a porous body during the sintering process occurs essentially invariant with respect to the directions x, y and z. “Essentially invariant” means that the difference in sintering behavior with respect to the directions x, y and z is in a range of not more than about +/−5%, or +/−2%, or +/−1%.

The present disclosure provides methods of making three-dimensional articles by locally controlling the composition of inkjetted droplets of sols. Advantageously, small droplet volumes of the sols enable generation of a fine resolution of one or more optical or mechanical properties exhibited by the three-dimensional articles.

More particularly, the present disclosure provides a method of making a three-dimensional article. The method comprises:
a) inkjetting a sol through a nozzle having a diameter of 10 micrometers to 70 micrometers to form a plurality of droplets of printed sol, wherein the sol comprises:
   i) 5 percent by volume (vol. %) to 40 vol. % of metal oxide particles, based on the total volume of the sol, the metal oxide particles having an average particle size of 20 nanometers (nm) or less and of 1/100 to 1/10,000 of a diameter of the nozzle;
   ii) a solvent;
   iii) a surface modifying agent; and
   iv) optionally a polymerizable component;
b) solidifying the printed sol to form a portion of the three-dimensional article; and
c) repeating steps a) and b) to form the three-dimensional article having a specified geometry.

The polymerizable component is present when the surface modifying agent does not also act as a polymerizable component. Optionally, the polymerizable component may be present even when the surface modifying agent does also act as a polymerizable component.

Prior work involving inkjet printing of compositions containing zirconia nanoparticles, for instance, reported that the presence of zirconia nanoparticles having a particle size of 10 nm affected ink printability even when present in a solid load of less than 1 percent by volume of the ink (“Zirconia nano-colloids transfer from continuous hydrothermal synthesis to inkjet printing”, Rosa et al., Journal of the European Ceramic Society, volume 39, 2019, pp. 2-8). Rosa et al. conducted inkjet experiments using inks containing 5.5±1 percent by weight solids. The percent by volume of zirconia solids would be 0.97±0.18 vol. %.

It has been unexpectedly discovered that sols containing 5 vol. % to 40 vol. % of metal oxide nanoparticles having an average particle size of 20 nm or less can successfully be inkjet printed through nozzles that are 100 to 10,000 times larger in diameter than the metal oxide nanoparticles, in methods according to the present disclosure. A combination of solvent(s), surface modifier(s), and polymerizable component(s) (and optionally other components such as stabilizer(s)) can be selected to achieve a desired viscosity, boiling point, and surface tension to successfully inkjet print the sol. The small nozzle diameter enables formation of small volume droplets, which can be used to create high resolution objects having variations in at least one optical and/or mechanical property. Selecting certain solvent(s) can minimize evaporation of solvent from a sol droplet following exiting the nozzle and prior to deposition on a surface. Further, the inclusion of 5 vol. % to 40 vol. %. of metal oxide nanoparticles is more useful than lower nanoparticle loadings if the inkjet-printed three-dimensional article will be sintered to form a ceramic article.

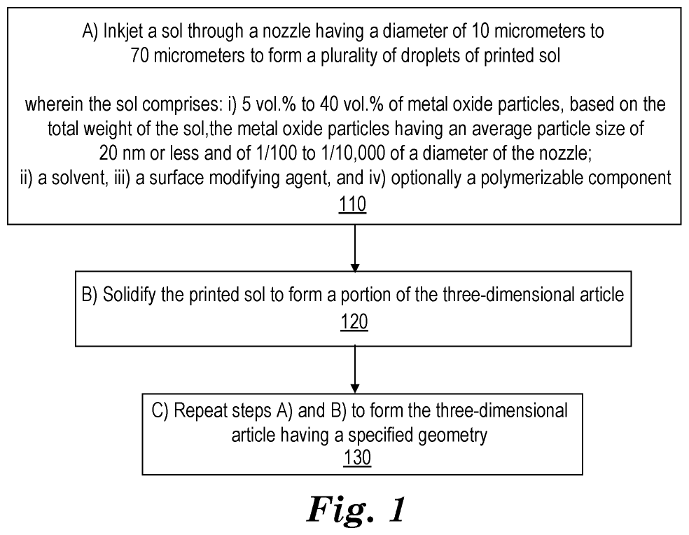

Referring to FIG. 1, a generalized flow chart is provided of a method of making a three-dimensional article. In particular, the method includes the Step of A) to inkjet a sol through a nozzle having a diameter of 10 micrometers to 70 micrometers to form a plurality of droplets of printed sol 110; wherein the sol comprises: i) 5 vol. % to 40 vol. % of metal oxide particles, based on the total volume of the sol, the metal oxide particles having an average particle size of 20 nm or less and of 1/100 to 1/10,000 of a diameter of the nozzle; ii) a solvent; iii) a surface modifying agent; and iv) optionally a polymerizable component. The method further includes the Step B) to solidify the printed sol to form a portion of the three-dimensional article 120. In some embodiments, the solidifying comprises drying the printed sol, e.g., by evaporation of at least a portion of the solvent from the sol in ambient conditions or using heat to accelerate the evaporation. Additionally, the method includes the Step C) to repeat steps A) and B) to form the three-dimensional article having a specified geometry 130. Often, the method includes moving (e.g., lifting) the printhead or a surface on which the droplets of sol were printed, at least after each step B), such as in a z axis. This can be done, for instance, to move the nozzle to allow space for a different nozzle to be moved in position to print the next droplet(s) of sol.

In some embodiments, the sol exits the nozzle as a plurality of uncured droplets each having a volume of 4 picoliters or greater, 5 picoliters, 6 picoliters, 7 picoliters, 8 picoliters, 9 picoliters, 10 picoliters, 12 picoliters, 15 picoliters, 17 picoliters, 20 picoliters, 22 picoliters, 25 picoliters, 27 picoliters, 30 picoliters, 32 picoliters, 35 picoliters, 37 picoliters, 40 picoliters, 42 picoliters, 45 picoliters, 47 picoliters, 50 picoliters or greater; and 200 picoliters or less, 190 picoliters, 180 picoliters, 170 picoliters, 160 picoliters, 150 picoliters, 140 picoliters, 130 picoliters, 120 picoliters, 110 picoliters, 100 picoliters, 95 picoliters, 90 picoliters, 85 picoliters, 80 picoliters, 75 picoliters, 70 picoliters, 65 picoliters, 60 picoliters, or 55 picoliters or less. Stated another way, the sol may exit the nozzle as a plurality of uncured droplets each having a volume of 4 picoliters to 200 picoliters, 4 picoliters to 100 picoliters, or 10 picoliters to 80 picoliters. The small volume of each uncured droplet contributes to achieving a high resolution of the three-dimensional article.

In some embodiments, the sol exits the nozzle at a drop rate of up to 20,000 hertz (Hz), up to 19,000 Hz, up to 18,000 Hz, up to 17,000 Hz, up to 16,000 Hz, up to 15,000 Hz, up to 14,000 Hz, up to 13,000 Hz, up to 12,000 Hz, up to 11,000 Hz, up to 10,000 Hz, up to 9,000 Hz, up to 8,000 Hz, up to 7,000 Hz, up to 6,000 Hz, up to 5,000 Hz, up to 4,000 Hz, or up to 3,000 Hz; and typically 1,000 Hz or greater or 2,000 Hz or greater.

In some embodiments, the sol has a dynamic viscosity of 2 milliPascal seconds (mPa·s) or greater at 23° C. and a shear rate of 10000 s⁻¹, 3 mPa·s, 5 mPa·s, 7 mPa·s, 10 mPa·s, 12 mPa·s, 15 mPa·s, 17 mPa·s, 20 mPa·s, 22 mPa·s, 25 mPa·s, 27 mPa·s, 30 mPa·s, 35 mPa·s, 40 mPa·s, 45 mPa·s, or 50 mPa·s or greater; and 150 mPa·s or less at 23° C. and a shear rate of 10000 s⁻¹. Stated another way, the sol may have a dynamic viscosity of 2 mPa·s to 150 mPa·s, 10 mPa·s to 100 mPa·s, or 15 mPa·s to 50 mPa·s, at 23° C. and a shear rate of 10000 s⁻¹. To decrease effective viscosity for inkjet printing the sol, the inkjet printer nozzle(s) can be heated, e.g., up to a temperature of 60° C., 70° C., or up to 80° C. If the viscosity of the sol is too high (or the local viscosity within a portion of the sol is too high) when the ink passes through the nozzle of the print head, metal oxide nanoparticles in the sol become unevenly dispersed. Such sols either cannot be processed through the inkjet nozzle heads or provide printed droplets of inconsistent nanoparticle content.

In some embodiments, the inkjet printer nozzle has a diameter of 10 micrometers or greater, 12 micrometers, 15 micrometers, 20 micrometers, 25 micrometers, 30 micrometers, or 35 micrometers or greater; and 70 micrometers or less, 65 micrometers, 60 micrometers, 55 micrometers, 50 micrometers, 45 micrometers, or 40 micrometers or less.

In some embodiments, the metal oxide particles have an average particle size that is 1/100 or less of a diameter of the inkjet printer nozzle, 1/200, 1/300, 1/400, 1/500, 1/600, 1/700, 1/800, 1/900, or 1/1,000 or less; and 1/10,000 or greater of a diameter of the inkjet printer nozzle, 1/9,000, 1/8,000, 1/7,000, 1/6,000, 1/5,000, 1/4,000, 1/3,000, or 1/2,000 or greater of a diameter of the inkjet printer nozzle. If the particles in the sol are too big, such that the ratio of average particle diameter to nozzle diameter is less than 1/100, the pressure of the sol passing through the nozzle may undesirably vary when a particle goes through the nozzle, resulting in droplet formation that is not homogenous.

In some embodiments, a portion of the droplets of the sol are printed on a support material, as known to the skilled practitioner. Suitable materials from which to form a support include for instance, wax or a matrix of printable sol that does not contain metal oxide particles.

In some embodiments, the inkjet printing is performed in an inert atmosphere. The inert atmosphere may be provided by filling or flushing the volume of space of an area or system with inert gas (e.g., nitrogen, krypton, neon, helium, argon, xenon, carbon dioxide, or nitrous oxide (N₂O)). Often, a vacuum is first pulled on the area or system to remove, e.g., ambient air, prior to adding the inert atmosphere. The inert atmosphere may be saturated with a solvent to minimize the possibility of solvent evaporating from the sol during printing. Evaporation risks sol clogging of the inkjet printer nozzles.

In some embodiments, the inkjet printing is performed in a closed system. Closed systems may be advantageous in that less control is required to maintain a desired solvent content, viscosity, and surface tension of the sol than when the inkjet printing is performed in an open system due to significantly less solvent evaporation occurring in a closed system. Alternatively, the inkjet printing is optionally performed in an open system. In certain systems, the method further comprises controlling a gas phase region of the system to maintain the desired solvent content, viscosity, and surface tension of the sol. This can be done by increasing a relative saturation of the solvent in the gas phase (e.g., to 60% or greater or 75% or greater). Increasing a relative saturation of the solvent in the gas phase may be performed by increasing a vapor pressure of the solvent in the gas phase region (e.g., by introducing solvent into the gas phase region, for instance by injection of solvent vapor), by reducing a temperature of the gas phase region (e.g., by 10° C. below ambient temperature), or by increasing a pressure of the gas phase region. Further details of methods for controlling a gas phase region of an additive manufacturing system are provided in co-owned International Application Publication WO 2019/111204 (Nelson et al.).

In some embodiments, the sol is a first sol and the method further comprises inkjetting through a nozzle having a diameter of 10 micrometers to 70 micrometers a droplet of a second sol onto a solidified printed droplet of the first sol, wherein the first sol and the second sol have different surface tensions. A suitable surface tension of a sol according to the present disclosure may be 0.02 Joules per square meter (J/m²) or greater, 0.025 J/m², 0.03 J/m², 0.035 J/m², or 0.04 J/m² or greater; and 0.08 J/m² or less, 0.075 J/m², 0.07 J/m², 0.065 J/m², 0.06 J/m², 0.055 J/m², 0.05 J/m², or 0.045 J/m² or less. In some embodiments, the sol has a surface tension of 0.02 J/m² to 0.08 J/m².

Optical properties often comprise color, translucency, and/or fluorescence. In some embodiments, the three-dimensional article has a specified optical appearance. Mechanical properties often comprise (e.g., tensile) strength, modulus, and/or hardness. In some embodiments, the three-dimensional article has one or more specified mechanical properties.

In some embodiments, the sol is a first sol and the method further comprises ink jetting through a nozzle having a diameter of 10 micrometers to 70 micrometers a droplet of a second sol onto a solidified printed droplet of the first sol, wherein the first sol and the second sol do not have the same composition. Often, a composition difference involves one or more elements that affect at least one optical property or at least one mechanical property of the resulting three-dimensional article (or a ceramic article following post-processing of the three-dimensional article).

In certain embodiments with high resolution inkjet printing, a three-dimensional article comprises an area of an exterior surface of 300 to 3,000 square micrometers comprising three (or more) different optical properties, e.g., including three different colors. In certain embodiments, a three-dimensional article comprises an area of an exterior surface of 300 to 3,000 square micrometers comprising three different mechanical properties. Similarly, for a ceramic article after sintering of a three-dimensional article, in certain embodiments the sintered ceramic article comprises a volume of 0.6 to 500 picoliters comprising three different optical properties, e.g., including color. In certain embodiments, the sintered ceramic article comprises a volume of 0.6 to 500 picoliters comprising three different mechanical properties. In certain embodiments, the article comprises a dental article having a body with x, y, and z dimensions of up to 2 cm in height×up to 2 cm in width×up to 10 cm in length.

Different compositions printed through separate inkjet nozzles may be used to provide the different optical properties and/or mechanical properties. For instance, an inkjet printer can print 3 or more materials (in some embodiments 4 or more, 5, 6, or 7 or more, such as up to 8 materials), each from a different print head.

For instance, a sol provides a certain appearance to a finished ceramic article. Usually, an additive is added to the substances used to make the sol particles themselves, prior to the particle synthesis. Zirconium or zirconyl acetate is typically used together with yttrium acetate to prepare a sol for a colorless ceramic (e.g., white). Possible additives to provide color are erbium acetate (e.g., pink), iron acetate (e.g., yellow), praseodymium acetate (e.g., yellow), terbium acetate (e.g., yellow), manganese acetate (e.g., grey), chromium acetate (e.g., grey), or cobalt acetate (e.g., grey/purple). It is possible to use, for example, four sols as base colors (e.g., white, pink, yellow, and grey) or to use a certain number of special premixed sols to control the optical properties within a final printed ceramic article, mostly color and translucency.

Methods of printing a three-dimensional article or object described herein includes inkjetting (at least one) sol through one or more nozzles. Further, the sol can be deposited according to an image of the three-dimensional article in a computer readable format. In some or all embodiments, the photocurable composition is deposited according to preselected computer aided design (CAD) parameters (e.g., a data file). It is further to be understood that the foregoing process can be repeated a selected number of times to provide the 3D article. Typically, each layer of a printed sol is solidified to form a portion of the 3D article prior to depositing further uncured sol droplets. The solidification can be carried out by removal of solvent (e.g., drying), applying energy to the layer of inkjet-printed sol droplets to polymerize the polymerizable component, or adjusting the pH of the inkjet-printed sol droplets to induce a polymerization reaction. In some cases, this process can be repeated “n” number of times to form the three-dimensional article having a specified geometry.

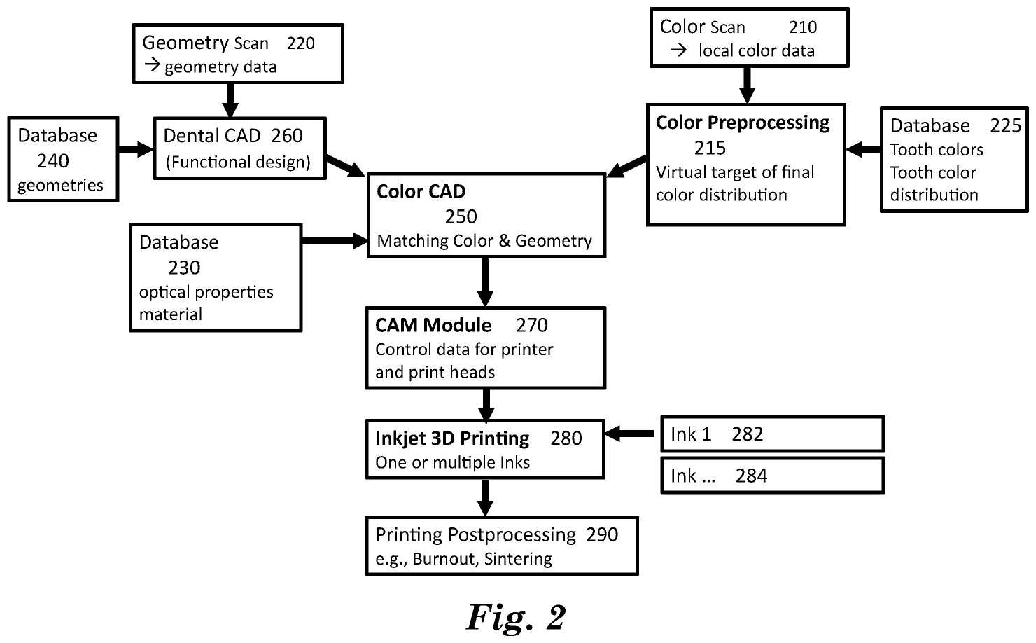

Referring to FIG. 2, a generalized process flow diagram is provided of one exemplary workflow for a method of making a personalized three-dimensional article. This particular workflow is directed to manufacturing a dental article that exhibits at least one optical property consistent with a person's original tooth. This workflow includes input comprising a color scan 210 to obtain color information across each of the x, y, and z axes, as well as information regarding the frequency and incident angle of the light used in the color scan. The input further comprises information from a database 225 containing data regarding tooth colors and tooth color distribution. The color scan input and the tooth color/tooth color distribution input are used in the step of color preprocessing 215, which involves manipulating the color scan information to calculate various parameters (e.g., light path information and color volume properties) to develop a visual target of a final color distribution. Input comprising geometry data from a geometry scan 220 provides dimensional information across each of the x, y, and z axes for the dental article. A database 240 provides input regarding article geometries. The geometry scan input and geometry database input are used in the dental computer aided design (CAD) step of functional design 260, which involves determining parameters to provide an article having at least the same function as the scanned object. More generally, scanning methods to scan a three-dimensional object may be employed to create the data representing the article. One exemplary technique for acquiring the data is digital scanning. Any other suitable scanning technique may be used for scanning an article, including X-ray radiography, laser scanning, computed tomography (CT), magnetic resonance imaging (MRI), and ultrasound imaging. Other possible scanning methods are described, e.g., in U.S. Patent Application Publication No. 2007/0031791 (Cinader, Jr., et al.). The initial digital data set, which may include both raw data from scanning operations and data representing articles derived from the raw data, can be processed to segment an article design from any surrounding structures (e.g., a support for the article).

The color preprocessing 215 and the functional design 260 are both inputted into the step of color CAD 250, as well as information retrieved from a database for optical properties of specific materials 230. The various inputs to the color CAD step 250 are used to map color and geometry to design a dental article to be inkjet printed. In this workflow, feedback can be provided regarding the color CAD by a patient or a dentist, e.g., to match surrounding dental surfaces. The color CAD information is fed to a computer aided manufacturing (CAM) module 270.

The CAM module 270 provides inkjet printer data regarding one or more sols, including, e.g., color properties. For instance, the CAM module 270 determines a mixing ratio of two or more materials for preparing each sol and sends the information to the printer in the form of bitmaps to control the printer and individual print heads. Next, an inkjet printer performs the step of inkjet 3D printing 280 by depositing one or more inks (e.g., ink 282 and/or ink 284) onto a substrate. Optionally, the deposited ink is solidified prior to depositing additional ink. Last, following inkjet printing of the three-dimensional article, the article undergoes post-processing during the final step 290. As mentioned above, such post-processing may include extracting solvent from the three-dimensional article to form an aerogel article or a xerogel article; heat treating the aerogel article or the xerogel article to form a porous ceramic article (e.g., burnout); and sintering the porous ceramic article to form a sintered ceramic article.

In alternate embodiments, a workflow such as depicted in FIG. 2 could be employed in which one or more mechanical properties or other optical properties are incorporated into the design of a three-dimensional article to be prepared using inkjet printing of sol(s) according to the present disclosure.

Accordingly, in some embodiments, a method according to the present disclosure further comprises, prior to Step A), performing a scan of an object and processing the scan to provide optical property data comprising the information of the two or more different optical properties. In certain embodiments, the method further comprises modifying the information based on feedback from a human being, e.g., matching a designed optical property to an optical property of an original material or object. Typically, the data comprises information that maps out two or more different optical properties located across a geometry of the digital object. In practice of the method, image files (e.g., bitmaps) control the nozzles of the inkjet printer.

Data representing a three-dimensional article (e.g., a dental article) may be generated using computer modeling, such as computer aided design (CAD) data. Image data representing the article design can be exported in STL format, or in any other suitable computer processable format, to the additive manufacturing equipment.

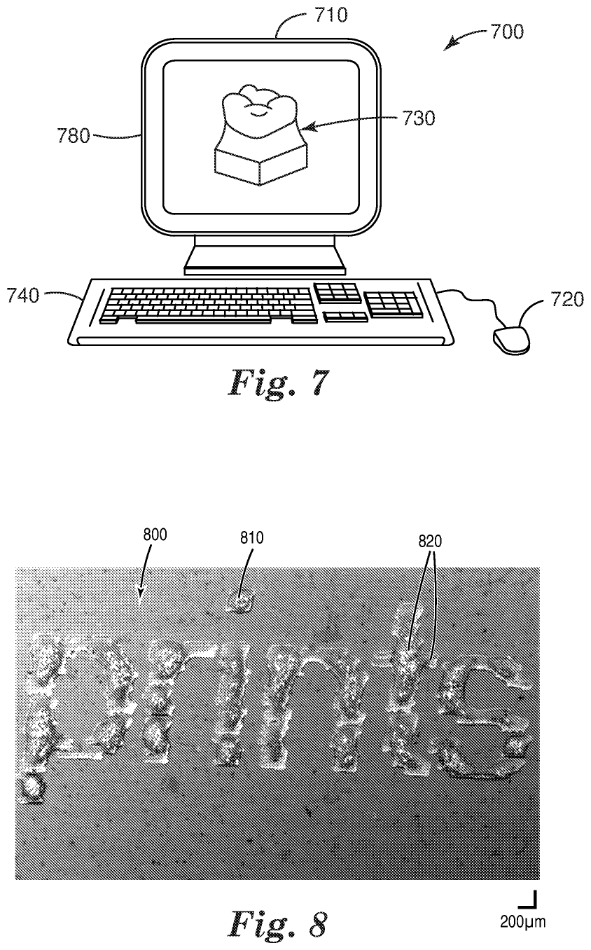

Often, machine-readable media are provided as part of a computing device. The computing device may have one or more processors, volatile memory (RAM), a device for reading machine-readable media, and input/output devices, such as a display, a keyboard, and a pointing device. Further, a computing device may also include other software, firmware, or combinations thereof, such as an operating system and other application software. A computing device may be, for example, a workstation, a laptop, a personal digital assistant (PDA), a server, a mainframe or any other general-purpose or application-specific computing device. A computing device may read executable software instructions from a computer-readable medium (such as a hard drive, a CD-ROM, or a computer memory), or may receive instructions from another source logically connected to a computer, such as another networked computer. Referring to FIG. 7, a computing device 700 often includes an internal processor 780, a display 710 (e.g., a monitor), and one or more input devices such as a keyboard 740 and a mouse 720. In FIG. 7, an article 730 (e.g., a dental crown article) is shown on the display 710.

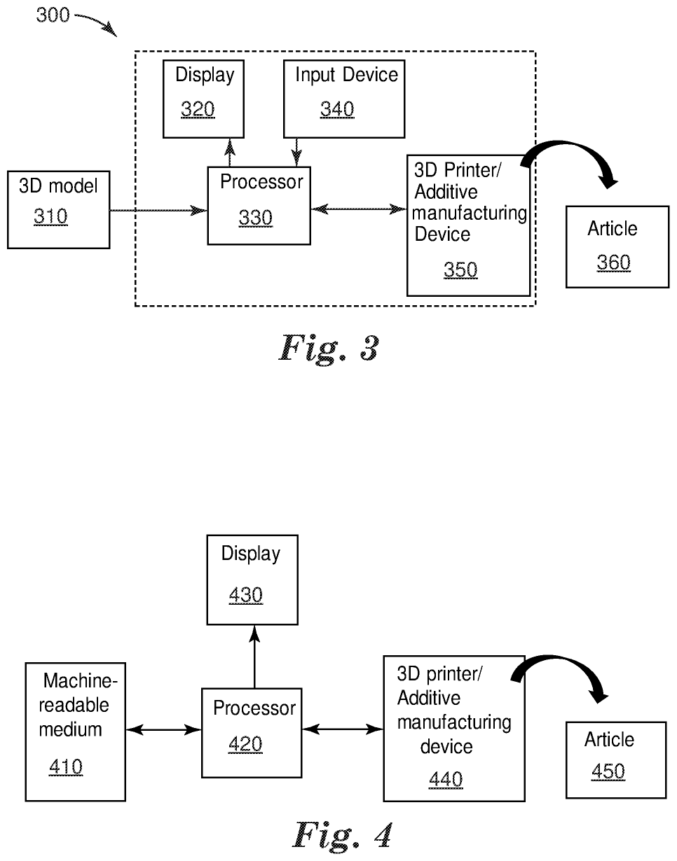

Referring to FIG. 3, in certain embodiments, the present disclosure provides a system 300. The system 300 comprises a display 320 that displays a 3D model 310 of an article (e.g., an article 730 as shown on the display 710 of FIG. 7); and one or more processors 330 that, in response to the 3D model 310 selected by a user, cause a 3D printer/additive manufacturing device 350 to create a physical object of the article 360. Often, an input device 340 (e.g., keyboard and/or mouse) is employed with the display 320 and the at least one processor 330, particularly for the user to select the 3D model 310.

Referring to FIG. 4, a processor 420 (or more than one processor) is in communication with each of a machine-readable medium 410 (e.g., a non-transitory medium), a 3D printer/additive manufacturing device 440, and optionally a display 430 for viewing by a user. The 3D printer/additive manufacturing device 440 is configured to make one or more articles 450 based on instructions from the processor 420 providing data representing a 3D model of the article 450 (e.g., an article 730 as shown on the display 710 of FIG. 7) from the machine-readable medium 410.

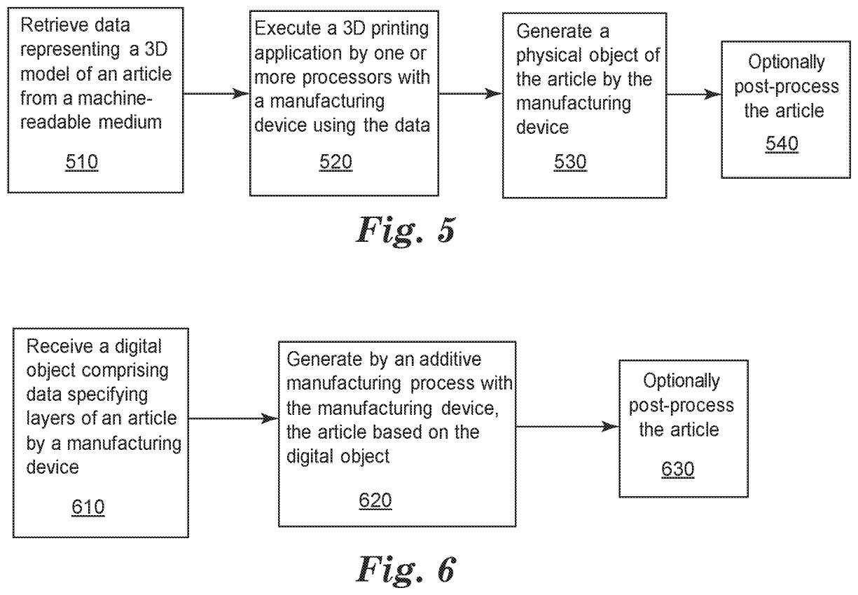

Referring to FIG. 5, for example and without limitation, an additive manufacturing method comprises retrieving 510, from a (e.g., non-transitory) machine-readable medium, data representing a 3D model of an article according to at least one embodiment of the present disclosure. The method further includes executing 520, by one or more processors, an additive manufacturing application interfacing with a manufacturing device using the data; and generating 530, by the manufacturing device, a physical object of the article. One or more various optional post-processing steps 540 may be undertaken. Typically, uncured photocurable component is removed from the article, plus the article may further be heat treated and/or sintered. For instance, in some embodiments, the method further comprises, prior to Step A): retrieving, from a non-transitory machine readable medium, data representing a 3D model of the three-dimensional article; and executing, by one or more processors, a 3D printing application interfacing with an inkjet printer using the data to generate, by the ink jet printer, a physical object of the three-dimensional article.

Additionally, referring to FIG. 6, a method of making an article comprises receiving 610, by a manufacturing device having one or more processors, a digital object comprising data specifying an (e.g., three-dimensional) article; and generating 620, with the manufacturing device by an additive manufacturing process, the article based on the digital object. Again, the article may undergo one or more steps of post-processing 630. For instance, in some embodiments, the method further comprises, prior to Step A): receiving, by a manufacturing device having one or more processors, a digital object comprising data specifying the three-dimensional article; and generating, with the manufacturing device by an additive manufacturing process, the three-dimensional article based on the digital object. The manufacturing device comprises at least one inkjet nozzle.

Referring to the methods of each of FIGS. 5 and 6, the data can comprise information that maps out two or more different optical properties located across a geometry of the digital object. Image files (e.g., bitmaps) typically control the inkjet nozzle(s). The two or more different optical properties often comprise color, translucency, and/or fluorescence.

In some embodiments, the method further comprises subjecting the three-dimensional article to actinic radiation (e.g., UV radiation, visible radiation, gamma radiation, or e-beam radiation), heat, and/or a vapor that adjusts a pH of the three-dimensional article. For instance, in some embodiments, different sols contain components that react together at a particular pH and thus can act as a two-component system when the sols are printed into direct contact with each other. Actinic radiation is typically applied having a sufficient energy to cure the polymerizable component of the sol.

In some embodiments, the method further comprises extracting solvent from the three-dimensional article to form an aerogel article or a xerogel article; heat treating the aerogel article or the xerogel article to form a porous ceramic article; and sintering the porous ceramic article to form a sintered ceramic article.

As noted above, an aerogel is a porous material derived from a gel, in which the liquid component of the gel (e.g., the three-dimensional article) has been replaced with a gas. The solvent removal (e.g., extraction) is often done under supercritical conditions. There is no capillary effect for this type of drying, and the linear shrinkage is often in a range of 0 to 25%, 0 to 20%, 0 to 15%, 5 to 15%, or 0 to 10%. The density typically remains uniform throughout the structure. In contrast, a xerogel is a three-dimensional solid derived from a gel (e.g., the three-dimensional article), in which the liquid component of the gel has been removed (e.g., extracted) by evaporation under ambient conditions or at an elevated temperature.

In some embodiments, the gelled body structure formed by the inkjet printing is compatible with and stable in a variety of solvents and conditions that may be necessary for supercritical extraction. Furthermore, the gel structure should be compatible with supercritical extraction fluids (e.g., supercritical carbon dioxide). In other words, the gels should be stable and strong enough to withstand drying, so as to produce stable aerogels and/or xerogels and give materials that can be heated to burn out the organics, pre-sintered, and densified without inducing cracks. Preferably, the resulting aerogels and/or xerogels have relatively small and uniform pore sizes to aid in sintering them to high density at low sintering temperatures. However, preferably the pores are large enough to allow product gases of organic burnout to escape without leading to cracking of the aerogel or xerogel. It is believed that the rapid nature of the gelation step results in an essentially homogeneous distribution of the ceramic particles throughout the gel, which can aid in the subsequent processing steps such as supercritical extraction, organic burnout, and sintering.

If applied, the supercritical drying step can be characterized by at least one, more, or all of the following features:
a) Temperature: 20° C. to 100° C., 30° C. to 80° C., or 15° C. to 150° C.;
b) Pressure: 5 to 200 MPa, 10 to 100 MPa, 1 to 20 MPa, or 5 to 15 MPa;
c) Duration: 2 to 175 hours, 5 to 25 hours, or 1 to 5 hours; and
d) Extraction or drying medium: carbon dioxide in its supercritical stage.

A combination of features (a), (b), (c), and (d) is sometimes preferred.

Supercritical extraction can remove all or most of the (e.g., organic) solvent in the inkjet-printed gel article. In some embodiments, the aerogels contain some residual solvent. The residual solvent can be up to 6 wt. % based on the total weight of the aerogel. For example, the aerogel can contain up to 5 wt. %, up to 4 wt. %, up to 3 wt. %, up to 2 wt. %, or up to 1 wt. % (e.g., organic) solvent.

The article obtained after having conducted the supercritical drying step can typically be characterized by at least one or more of the following properties:
showing a N₂ adsorption and/or desorption isotherm with a hysteresis loop;
showing a N₂ adsorption and desorption of isotherm type IV according to IUPAC classification and a hysteresis loop;
showing a N₂ adsorption and desorption isotherm of type IV with a hysteresis loop of type H1 according to IUPAC classification;
showing a N₂ adsorption and desorption isotherm of type IV with a hysteresis loop of type H1 according to IUPAC classification in a p/p0 range of 0.70 to 0.99.

Heat treating of an aerogel article or xerogel article to form a porous ceramic article may be performed (usually in an atmosphere that includes oxygen) at a temperature of 70 degrees Celsius (° C.) or greater, 80° C. or greater, 90° C. or greater, 100° C. or greater, 125° C. or greater, 150° C. or greater, 175° C. or greater, 200° C. or greater, 250° C. or greater, 300° C. or greater, 400° C. or greater, 500° C. or greater, 600° C. or greater, or 700° C. or greater; and 1200° C. or less, 1100° C. or less, 1000° C. or less, 900° C. or less, or 800° C. or less. Stated another way, heat treating may be performed at a temperature of 70° C. to 1200° C.

### Sol Components

### Metal Oxide Particles

In some embodiments, the metal oxide particles have an average (mean) diameter (i.e., D₅₀) of 1 nm or greater, 2 nm, 3 nm, 4 nm, 5 nm, 6 nm, 7 nm, 8 nm, or 9 nm or greater; and 20 nm or less, 19 nm, 18 nm, 17 nm, 16 nm, 15 nm, 14 nm, 13 nm, 12 nm, 11 nm, or 10 nm or less, preferably 6 nm or greater and 20 nm or less. Such small particle size is advantageous in managing abrasion of the inkjet printer nozzle, as larger particles tend to cause greater undesirable nozzle surface abrasion.

In some embodiments, the metal oxide particles are present in an amount of 5 vol. % or greater, based on the total volume of the sol, 6 vol. %, 7 vol. %, 8 vol. %, 9 vol. %, 10 vol. %, 11 vol. %, 12 vol. %, 13 vol. %, 14 vol. %, or 15 vol. % or greater; and 40 vol. % or less, based on the total volume of the sol, 38 vol. %, 36 vol. %, 35 vol. %, 34 vol. %, 32 vol. %, 30 vol. %, 28 vol. %, 26 vol. %, 25 vol. %, 24 vol. %, 22 vol. %, 20 vol. %, 19 vol. %, 18 vol. %, 17 vol. %, or 16 vol. % or less. Stated another way, sols may comprise 5 vol. % to 40 vol. %, 5 vol. % to 30 vol. %, 8 vol. % to 40 vol. %, 8 vol. % to 30 vol. %, or 10 vol. % to 30 vol. % of the metal oxide particles, based on the total volume of the sol.

In some embodiments, the metal oxide particles are present in an amount of 20 wt. % or greater, based on the total weight of the sol, 22 wt. %, 25 wt. %, 28 wt. %, 30 wt. %, 31 wt. %, 32 wt. %, 33 wt. %, 34 wt. %, 35 wt. %, 36 wt. %, 37 wt. %, 38 wt. %, 39 wt. %, 40 wt. %, 41 wt. %, 42 wt. %, 43 wt. %, or 44 wt. % or greater; and 60 wt. % or less, based on the total weight of the sol, 59 wt. %, 58 wt. %, 57 wt. %, 56 wt. %, 55 wt. %, 54 wt. %, 53 wt. %, 52 wt. %, 51 wt. %, 50 wt. %, 49 wt. %, 48 wt. %, 47 wt. %, or 46 wt. % or less. Stated another way, sols may comprise 20 wt. % to 60 wt. %, 25 wt. % to 60 wt. %, 30 wt. % to 60 wt. %, 35 wt. % to 60 wt. %, 40 wt. % to 60 wt. %, or 30 wt. % to 45 wt. % of the metal oxide particles, based on the total weight of the sol. These weight percent amounts are particularly suitable when the metal oxide particles are zirconia.

Examples of suitable metal oxide nanoparticles include metal oxides of zirconium, silicon, titanium, aluminum, hafnium, zinc, tin, cerium, yttrium, indium, and antimony, as well as mixed metal oxides such as, for example, indium tin oxide. Particularly suitable are zirconia and silica. In some embodiments, zirconia is preferable, while in other embodiments, silica is preferable.

Suitable zirconia particles include for instance and without limitation, nano-sized zirconia particles(s) having at least one and up to all of the following parameters or features:
Primary particle size XRD (diameter) from 2 to 50 nm, 2 to 20 nm, 2 to 15 nm, or 4 to 15 nm;
being essentially spherical, cuboid or a mixture of spherical and cuboid;
being non-associated;
being crystalline;
not being coated with an inorganic coloring agent.

Suitable nano-sized zirconia particles can have at least one and up to all of the following features:
ZrO₂ content: from 70 to 100 mol % or 80 to 97 mol %;
HfO₂ content: from 0 to 4.5 mol %, 0 to 3 mol %, or 0.1 to 2.8 mol %;
Stabilizer selected from Y₂O₃, CeO₂, MgO, CaO, La₂O₃ or a combination thereof in an amount from 0 to 30 mol %, 1.5 to 16 mol %, 2 to 10 mol %, 2 to 7 mol %, or 2 to 5 mol %;
Al₂O₃ content: from 0 to 1 mol %, or from 0.005 to 0.5 mol %, or from 0.01 to 0.2 mol %.

According to one embodiment, the nano-sized zirconia particles are characterized as follows: ZrO₂ content from 70 to 98.4 mol %; HfO₂ content from 0.1 to 2.8 mol %; Y₂O₃ content from 1.5 to 28 mol %.

Nano-sized zirconia particles can be obtained or are obtainable by a process comprising the steps of hydrothermal treatment of an aqueous metal salt solution or suspension (e.g. zirconium salt, yttrium salt). Such a process is described in WO 2013/055432 (Kolb et al.).

Suitable silica particles include for instance and without limitation spherical silica particles and non-spherical silica particles. Spherical silica particles in aqueous media (sols) are well known in the art and are available commercially; for example, as silica sols in water or aqueous alcohol solutions under the trade designations LUDOX from W.R. Grace & Co. (Columbia, MD), NYACOL from Nyacol Nanotechnologies Inc. (Ashland, MA), or NALCO from Nalco Company (Naperville, IL). One useful silica sol with a volume average particle size of 5 nm, a pH of 10.5, and a nominal solids content of 15 percent by weight, is available as NALCO 2326 from Nalco Company. Other useful commercially available silica sols include those available as NALCO 1115 and NALCO 1130 from Nalco Company, as REMASOL SP30 from Remet Corp. (Utica, NY), and as LUDOX SM from W.R. Grace & Co. Other suitable silica particles include fumed silica. Agglomerated silica particles are commercially available, e.g., from Degussa, Cabot Corp or Wacker under the product designation AEROSIL, CAB-O-SIL and HDK, respectively. The specific surface area of the hydrophobic fumed silica is typically from 100 to 300 m²/g or from 150 to 250 m²/g. A mixture of different fumed silicas can be used, if desired. For example, a mixture of fumed silica the surface of which has been treated with a hydrophobic surface treating agent and fumed silica the surface of which has been treated with a hydrophilic surface treating agent can be used. A suitable nano-silica comprising aggregated nano-sized particles can be produced according to the processes described e.g. in U.S. Pat. No. 6,730,156 (Zhang et al., preparatory example A).

Suitable yttria particles include for instance and without limitation yttrium oxide available from Treibacher Industrie AG (Althofen, Austria).

In many embodiments, the sol further comprises one or more elements selected from the group consisting of Mn, Fe, Cu, Pr, Nd, Sm, Eu, Tb, Dy, Er, Cr, Co, Ni, Al, Ti, V, Ta, Y, Ce, Mg, Ca, La, Sc, and Bi, wherein the one or more elements are provided within at least one plurality of particles. In select embodiments, the one or more elements comprise Y, Ce, Ca, Mg, Sc, and/or La. Often, such one or more elements are provided as one or more additional elements within the metal oxide particles. These elements may be provided as an oxide or a salt, for instance an oxide of Er, Tb, Mn, Bi, Nd, Fe, Pr, Co, Cr, V, Cu, Eu, Sm, Dy, Tb, or combinations thereof.

These elements can impart at least one of color, stability, fluorescence, or translucency to an article when included in the sol. For instance, Y₂O₃, CeO₂, MgO, CaO, an/or La₂O₃ are useful stabilizers. Similarly, the oxides and/or salts of Mn, Fe, Cu, Pr, Nd, Sm, Eu, Tb, Dy, Er, Bi, or combinations thereof, with Er, Tb, Mn, Bi, Nd being sometimes preferred, can be good inorganic coloring agents.

### Solvent

Sols suitable for use in methods of the present disclosure contain at least one solvent. In some embodiments, the solvent comprises one or more of water or an alcohol. In some embodiments, the solvent medium contains less than 15 wt. % water, less than 10 wt. % water, less than 5 wt. % water, less than 3 wt. % water, less than 2 wt. % water, or less than 1 wt. % water.

According to certain embodiments, the solvent is a glycol or polyglycol, mono-ether glycol or mono-ether polyglycol, di-ether glycol or di-ether polyglycol, ether ester glycol or ether ester polyglycol, carbonate, amide, or sulfoxide (e.g., dimethyl sulfoxide). The organic solvents usually have one or more polar groups, such as ether, alcohol, or carboxy moieties, to enhance the dissolving capability or property of the solvent. The organic solvent is often selected to be soluble in supercritical carbon dioxide or liquid carbon dioxide. In some embodiments, using a mixture of solvents can be beneficial. The solvent(s) can be selected to adjust certain properties of the sol, e.g., boiling point, viscosity or surface tension, or to facilitate post-processing steps, e.g., solvent extraction. The organic solvent does not have a polymerizable group; that is, the organic solvent is free of a group that can undergo free radical polymerization. Further, no component of the solvent medium has a polymerizable group that can undergo free radical polymerization.

Suitable glycols or polyglycols, mono-ether glycols or mono-ether polyglycols, di-ether glycols or di-ether polyglycols, and ether ester glycols or ether ester polyglycols are often of the following Formula (I).

R¹O—(R²O)—R¹ (I)

In Formula (I), each R¹ independently is hydrogen, alkyl, aryl, or acyl. Suitable alkyl groups often have 1 to 10 carbon atoms, 1 to 6 carbon atoms, or 1 to 4 carbon atoms. Suitable aryl groups often have 6 to 10 carbon atoms and are often phenyl or phenyl substituted with an alkyl group having 1 to 4 carbon atoms. Suitable acyl groups are often of formula —(CO)Ra where Ra is an alkyl having 1 to 10 carbon atoms, 1 to 6 carbon atoms, 1 to 4 carbon atoms, 2 carbon atoms, or 1 carbon atom. The acyl is often an acetyl group (—(CO)CH₃). In Formula (I), each R² is typically ethylene or propylene. The variable n is at least 1 and can be in a range of 1 to 10, 1 to 6, 1 to 4, or 1 to 3.

Glycols or polyglycols of Formula (I) have two R¹ groups equal to hydrogen. Examples of glycols include, but are not limited to, ethylene glycol, propylene glycol, diethylene glycol, dipropylene glycol, triethylene glycol, and tripropylene glycol.

Mono-ether glycols or mono-ether polyglycols of Formula (I) have a first R¹ group equal to hydrogen and a second R¹ group equal to alkyl or aryl. Examples of mono-ether glycols or mono-ether polyglycols include, but are not limited to, ethylene glycol monohexyl ether, ethylene glycol monophenyl ether, propylene glycol monobutyl ether, diethylene glycol monomethyl ether, diethylene glycol monoethyl ether, diethylene glycol monopropyl ether, diethylene glycol monobutyl ether, diethylene glycol monohexyl ether, dipropylene glycol monomethyl ether, dipropylene glycol monoethyl ether, dipropylene glycol monopropyl ether, triethylene glycol monomethyl ether, triethylene glycol monoethyl ether, triethylene glycol monobutyl ether, tripropylene glycol monomethyl ether, and tripropylene glycol monobutyl ether.

Di-ether glycols or di-ether polyglycols of Formula (I) have two R¹ groups equal to alkyl or aryl. Examples of di-ether glycols or di-ether polyglycols include, but are not limited to, ethylene glycol dipropyl ether, ethylene glycol dibutyl ether, dipropylene glycol dibutyl ether, diethylene glycol dimethyl ether, diethylene glycol diethyl ether, triethylene glycol dimethyl ether, tetraethylene glycol dimethyl ether, and pentaethylene glycol dimethyl ether.

Ether ester glycols or ether ester polyglycols of Formula (I) have a first R¹ group equal to an alkyl or aryl and a second R¹ group equal to an acyl. Examples of ether ester glycols or ether ester polyglycols include, but are not limited to, ethylene glycol butyl ether acetate, diethylene glycol butyl ether acetate, and diethylene glycol ethyl ether acetate.

Other suitable organic solvents are carbonates of Formula (II).

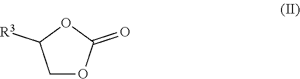

In Formula (II), R³ is hydrogen or an alkyl such as an alkyl having 1 to 4 carbon atoms, 1 to 3 carbon atoms, or 1 carbon atom. Examples include ethylene carbonate and propylene carbonate.

Yet other suitable organic solvents are amides of Formula (III).

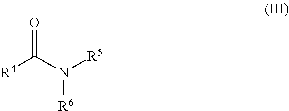

In Formula (III), group R⁴ is hydrogen, alkyl, or combines with R⁵ to form a five-membered ring including the carbonyl attached to R⁴ and the nitrogen atom attached to R⁵. Group R is hydrogen, alkyl, or combines with R⁴ to form a five-membered ring including the carbonyl attached to R⁴ and the nitrogen atom attached to R⁵. Group R is hydrogen or alkyl. Suitable alkyl groups for R⁴, R⁵, and R have 1 to 6 carbon atoms, 1 to 4 carbon atoms, 1 to 3 carbon atoms, or 1 carbon atom. Examples of amide organic solvents of Formula (III) include, but are not limited to, formamide, N,N-dimethylformamide, N,N-dimethylacetamide, N,N-diethylacetamide, N-methyl-2-pyrrolidone, and N-ethyl-2-pyrrolidone.

Specific examples of solvents which can be used include: mono alcohols (e.g. C2 to C8 alcohols, including primary, secondary and tertiary alcohols), poly alcohols (e.g. C2 to C8 alcohols, including ethylene glycol, propylene glycol, and glycerine), diethylene glycol ethyl ether (CARBITOL), 1-methoxy-2-propanol, N-methyl pyrrolidone, acetonitrile, chlorobenzene, 1,4-dioxane, ethyl acetate, methyl ethyl ketone, tetrahydrofuran, toluene, xylene, and mixtures thereof.

The following solvents are sometimes preferred: ethanol, propanol, methanol, ethylene glycol, propylene glycol, glycerine, diethylene glycol ethyl ether, 1-methoxy-2-propanol, or mixtures thereof.

In some situations, suitable solvents may also include low boiling alcohols (below 100° C.; like methanol, ethanol, propanol) and mixtures thereof or preferably with the same solvent(s) described above. It is sometimes preferable that the one or more solvents have a boiling point above a temperature employed during the inkjet process to minimize solvent evaporation. For instance, in certain embodiments, at least one solvent in the sol has a boiling point of 150° C. or greater, 160° C. or greater, 170° C. or greater, 180° C. or greater, or 190° C. or greater.

The solvent(s) is typically present in an amount of at least 20 wt. % or greater, 25 wt. %, 30 wt. %, or 35 wt. % or greater; and 75 wt. % or less, 70 wt. %, 65 wt. %, or 60 wt. % or less. Stated another way, the solvent(s) may be present in an amount from 20 wt. % to 75 wt. %, from 20 wt. % to 70 wt. %, from 20 wt. % to 65 wt. %, from 25 wt. % to 75 wt. %, from 25 wt. % to 70 wt. %, from 25 wt. % to 65 wt. %, from 25 wt. % to 60 wt. %, from 30 wt. % to 70 wt. %, from 30 wt. % to 65 wt. %, from 35 wt. % to 70 wt. %, from 35 wt. % to 65 wt. %, or from 35 wt. % to 60 wt. %, with respect to the weight of the total printing sol.

### Surface Modifying Agent

A surface modifying agent assists in dispersing the metal oxide particles by making the particles more compatible with the solvent(s). The surface modifying agent may also help to improve compatibility of the metal oxide particles contained in the sol with a polymerizable component present in the sol, and can be used to adjust the viscosity of the sol. A surface modifying agent is usually a carboxylic acid or a salt thereof, sulfonic acid or salt thereof, phosphoric acid or salt thereof, phosphonic acid or salt thereof, or silane that can attach to the surface of the metal oxide particles. More than one surface modifying agent can be used.

In some embodiments, the surface modifying agent comprises a compound of Formula (IV):

H₃CO—[(CH₂)_{y}O]_{z}-Q-COOH (IV),

wherein Q is a divalent organic linking group, z is an integer in the range of 1 to 10, and y is an integer in the range of 1 to 4. In select embodiments, Q can be an alkylene, e.g., —(CH₂)x-, where x is an integer in the range of 1 to 10.

In certain embodiments, the surface modifying agent comprises a compound of Formula (V):

X—COOH (V),

wherein X is miscible with the solvent. For instance, when the solvent comprises water, a particularly suitable surface modifying agent may include acetic acid. When the solvent comprises diethylene glycol ethyl ether, a particularly suitable surface modifying agent may include 2-[2-(2-methoxyethoxy)ethoxy]acetic acid (“MEEAA”).

For sols containing silica nanoparticles, silane surface modifying agents are often preferred. Example silane surface modifying agents include, but are not limited to, propyltrimethoxysilane, propyltriethoxysilane, hexyltrimethoxysilane, hexyltriethoxysilane, isooctyltrimethoxysilane, n-octyltriethoxysilane, n-octyltrimethoxysilane, octadecyltrimethoxysilane, decyltrimethoxysilane, decyltriethoxysilane, dodecyltrimethoxysilane, phenyltrimethoxysilane, phenyltriethoxysilane, N-(3-triethoxysilylpropyl)methoxyethoxyethoxyethyl carbamate, and N-(3-triethoxysilylpropyl)methoxyethoxyethyl carbamate. Another example silane compound is available from Momentive Performance Materials, Wilton, CT, under the trade designation SILQUEST A1230. Still other suitable silane compounds are commercially available, for example, from Gelest (Morrisville, PA, USA) and Shin-Etsu Silicones (Akron, OH, USA).

A surface modifying agent is often present in an amount of 0.5 wt. % or greater, based on the total weight of the metal oxide particles, 1 wt. %, 1.5 wt. %, 2 wt. %, 2.5 wt. %, 3 wt. %, 3.5 wt. %, 4 wt. %, 4.5 wt. % or 5 wt. % or greater; and 25 wt. % or less, 24 wt. %, 23 wt. %, 22 wt. %, 21 wt. %, 20 wt. %, 19 wt. %, 18 wt. %, 17 wt. %, or 16 wt. % or less, based on the total weight of the metal oxide particles. Stated another way, the surface modifying agent may be present in an amount of 0.5 wt. % to 25 wt. %, based on the total weight of the metal oxide particles. These amounts are particularly suitable when the metal oxide particles are zirconia.

In some embodiments, surface modifying agents may be represented by the formula A-B, where the A group is capable of attaching to the surface of a metal oxide particle and the B group is radiation curable. Group A can be attached to the surface of the metal oxide particle by adsorption, formation of an ionic bond, formation of a covalent bond, or a combination thereof. Examples for Group A include acidic moieties (like carboxylic acid groups, phosphoric acid groups, sulfonic acid groups and anions thereof) and silanes. Group B comprises a radiation curable moiety. Examples for Group B include vinyl, in particular acryl or methacryl moieties.

Suitable surface modifying agents comprise polymerizable carboxylic acids and/or anions thereof, polymerizable sulfonic acids and/or anions thereof, polymerizable phosphoric acids and/or anions thereof, and polymerizable silanes. Suitable surface modifying agents are further described, for example, in WO 2009/085926 (Kolb et al.), the disclosure of which is incorporated herein by reference.

An example of a radically polymerizable surface modifying agent is a polymerizable material comprising an acidic moiety or anion thereof, e.g. a carboxylic acid group. Exemplary acidic radically polymerizable surface modifying agents include acrylic acid, methacrylic acid, beta-carboxyethyl acrylate, and mono-2-(methacryloxyethyl)succinate. Exemplary radically polymerizable surface modifying agents can be reaction products of hydroxyl-containing polymerizable monomers with cyclic anhydrides such as succinic anhydride, maleic anhydride and phthalic anhydride. Exemplary polymerizable hydroxyl-containing monomers include hydroxyethyl acrylate, hydroxyethyl methacrylate, hydroxypropyl acrylate, hydroxypropyl methacrylate, hydroxyl butyl acrylate, and hydroxybutyl methacrylate. Acryloxy- and methacryloxy-functional polyethylene oxide and polypropylene oxide may also be used as the polymerizable hydroxyl-containing monomers. An exemplary radically polymerizable surface modifying agent for imparting both polar character and reactivity to metal oxide particles is mono(methacryloxypolyethyleneglycol) succinate.

In select embodiments, the radically polymerizable surface modifying agent is a polymerizable silane. Exemplary polymerizable silanes include methacryloxyalkyltrialkoxysilanes or acryloxyalkyltrialkoxysilanes (e.g., 3-methacryloxypropyltrimethoxysilane, 3-acryloxypropyl-trimethoxysilane, and 3-(meth)acryloxypropyltriethoxysilane); methacryloxyalkylalkyldialkoxysilanes or acryloxyalkylalkyldialkoxysilanes (e.g., 3-methacryloxypropylmethyldimethoxysilane, and 3-acryloxypropylmethyldimethoxysilane); methacryloxyalkyldialkylalkoxysilanes or acyrloxyalkyldialkylalkoxysilanes (e.g., 3-methacryloxypropyldimethylethoxysilane); mercaptoalkyltrialkoxylsilanes (e.g., 3-mercapto-propyltrimethoxysilane); aryltrialkoxysilanes (e.g., styrylethyltrimethoxysilane); and vinylsilanes (e.g., vinylmethyldiacetoxysilane, vinyldimethylethoxysilane, vinylmethyldiethoxysilane, vinyltrimethoxysilane, vinyltriethoxysilane, vinyltriacetoxysilane, vinyltriisopropoxysilane, vinyltrimethoxysilane, and vinyltris(2-methoxyethoxy)silane).

A surface modifying agent can be added to the metal oxide particles using conventional techniques, before or after any removal of at least a portion of a resulting sol from manufacturing the metal oxide particles (e.g., water, carboxylic acids, and/or anions thereof from a zirconia-based sol). The polymerizable component can be added before or after surface modification or simultaneously with surface modification. Various methods of adding the surface modifying agent are further described, for example, in WO 2009/085926 (Kolb et al.), the disclosure of which is incorporated herein by reference.

The surface modification reactions can occur at room temperature (e.g., 20° C. to 25° C.) or at an elevated temperature (e.g., up to 95° C.). When the surface modifying agents are acids such as carboxylic acids, the metal oxide particles typically can be surface-modified at room temperature. When the surface modifying agents are silanes, the metal oxide particles are typically surface modified at elevated temperatures.

### Polymerizable Component

In some embodiments, the polymerizable component comprises one or more curable monomers or oligomers. In particular, when the surface modifying agent does not also act as a polymerizable component, a separate polymerizable component is included. A separate polymerizable component is often included in addition to a polymerizable surface modifying agent. For clarity, a surface modifying agent that also acts as a polymerizable component will be referred to as a “first” monomer, and a different monomer included as a polymerizable component will be referred to as one or more “second” monomers.

In some embodiments, second monomers, when present, comprise at least one or two radiation curable moieties. In particular, second monomers comprising at least two radiation curable moieties may act as crosslinker(s) during curing following deposition of ink droplet(s). Any suitable second monomer that does not have a surface modification group can be used. The second monomer does not have a group being capable of attaching to the surface of a metal oxide particle. That is, the optional second monomer does not have a carboxylic acid group or a silyl group. The second monomers are often polar monomers (e.g., non-acidic polar monomers), monomers having a plurality of polymerizable groups, alkyl (meth)acrylates and mixtures thereof.

A successful print typically requires a certain level of gel strength as well as shape resolution and adding a second monomer comprising at least two radiation curable moieties to the sol described herein may facilitate the optimization of both properties. A crosslinked approach often allows for greater gel strength to be realized at a lower energy dose since the polymerization creates a stronger network. In some examples, higher energy doses have been applied to increase layer adhesion of non-crosslinked systems. The presence of a monomer having a plurality of polymerizable groups tends to enhance the strength of the gel composition formed when the sol is polymerized. The amount of the monomer with a plurality of polymerizable groups can be used to adjust the flexibility and the strength of the gelled body, and indirectly optimize the gelled body resolution and final article resolution. Such gel compositions can be easier to process without cracking, and in the case of transforming the gel into a fully dense ceramic, increased gel strength aids in the robustness of the post-printing procedures.

In many embodiments, the second monomer includes a monomer having a plurality of polymerizable groups. The number of polymerizable groups can be in a range of 2 to 6 or even higher. In many embodiments, the number of polymerizable groups is in a range of 2 to 5 or 2 to 4. The polymerizable groups are typically (meth)acryloyl groups.

Exemplary monomers with two (meth)acryloyl groups include 1,2-ethanediol diacrylate, 1,3-propanediol diacrylate, 1,9-nonanediol diacrylate, 1,12-dodecanediol diacrylate, 1,4-butanediol diacrylate, 1,6-hexanediol diacrylate, butylene glycol diacrylate, bisphenol A diacrylate, diethylene glycol diacrylate, triethylene glycol diacrylate, tetraethylene glycol diacrylate, tripropylene glycol diacrylate, polyethylene glycol diacrylate, polypropylene glycol diacrylate, polyethylene/polypropylene copolymer diacrylate, polybutadiene di(meth)acrylate, propoxylated glycerin tri(meth)acrylate, and neopentylglycol hydroxypivalate diacrylate modified caprolactone.

Exemplary monomers with three or four (meth)acryloyl groups include, but are not limited to, trimethylolpropane triacrylate (e.g., commercially available under the trade designation TMPTA-N from Cytec Industries, Inc. (Smyrna, GA, USA) and under the trade designation SR-351 from Sartomer (Exton, PA, USA)), pentaerythritol triacrylate (e.g., commercially available under the trade designation SR-444 from Sartomer), ethoxylated (3) trimethylolpropane triacrylate (e.g., commercially available under the trade designation SR-454 from Sartomer), ethoxylated (4) pentaerythritol tetraacrylate (e.g., commercially available under the trade designation SR-494 from Sartomer), tris(2-hydroxyethylisocyanurate) triacrylate (e.g., commercially available under the trade designation SR-368 from Sartomer), a mixture of pentaerythritol triacrylate and pentaerythritol tetraacrylate (e.g., commercially available from Cytec Industries, Inc., under the trade designation PETIA with an approximately 1:1 ratio of tetraacrylate to triacrylate and under the trade designation PETA-K with an approximately 3:1 ratio of tetraacrylate to triacrylate), pentaerythritol tetraacrylate (e.g., commercially available under the trade designation SR-295 from Sartomer), and di-trimethylolpropane tetraacrylate (e.g., commercially available under the trade designation SR-355 from Sartomer).

Exemplary monomers with five or six (meth)acryloyl groups include, but are not limited to, dipentaerythritol pentaacrylate (e.g., commercially available under the trade designation SR-399 from Sartomer) and a hexa-functional urethane acrylate (e.g., commercially available under the trade designation CN975 from Sartomer).

In some embodiments, a polymerizable component comprises an epoxy. Epoxy compounds which are suitable for use in sols include, for instance and without limitation, cycloaliphatic oxiranes, aliphatic oxiranes, aromatic oxiranes, or a combination thereof. These compounds, which are widely known as epoxy compounds, can be monomeric, oligomeric, polymeric, or mixtures thereof. These materials generally have, on the average, at least one polymerizable epoxy group (oxirane unit) per molecule, and preferably at least about 1.5 polymerizable epoxy groups per molecule. The polymeric epoxides include linear polymers having terminal epoxy groups (e.g., a diglycidyl ether of a polyoxyalkylene glycol), polymers having skeletal oxirane units (e.g., polybutadiene polyepoxide), and polymers having pendent epoxy groups (e.g., a glycidyl methacrylate polymer or copolymer). The epoxides may be pure compounds or may be mixtures containing one, two, or more epoxy groups per molecule. The “average” number of epoxy groups per molecule is determined by dividing the total number of epoxy groups in epoxy-containing material by the total number of epoxy molecules present. The epoxy compounds may have a molecular weight of from about 58 to about 100,000 or more.

Suitable epoxy compounds include those that contain cyclohexene oxide groups, such as the epoxycyclohexanecarboxylates, for example, 3,4-epoxycyclohexylmethyl-3,4-epoxy cyclohexanecarboxylate, 3,4-epoxy-2-methylcyclohexylmethyl-3,4-epoxy-2-methylcyclohexane carboxylate, and bis(3,4-epoxy-6-methylcyclohexylmethyl) adipate. A more detailed list of useful epoxides of this nature is provided in U.S. Pat. No. 3,117,099 (Proops et al.).

Suitable epoxy compounds also include glycidyl ether compounds, such as glycidoxyalkyl and glycidoxyaryl compounds containing 1 to 6 glycidoxy groups. Examples include glycidyl ethers of polyhydric phenols, which can be obtained by reacting the polyhydric phenol with an excess of epichlorohydrin to provide, for example, 2,2-bis(2,3-epoxypropoxyphenyl)propane. Additional epoxides of this type are described in U.S. Pat. No. 3,018,262 (Schroeder), and in “Handbook of Epoxy Resins” by Lee and Neville, McGraw-Hill Book Co., New York (1967). Many suitable epoxy compounds are commercially available and are listed in U.S. Pat. No. 6,187,833 (Oxman et al.).

Some sol compositions typically contain 0 to 90 wt. % of a second monomer having a plurality of polymerizable groups based on a total weight of the polymerizable component. For example, the amount can be in a range of 5 to 90 wt. %, 10 to 90 wt. %, 20 to 90 wt. %, 30 to 90 wt. %, 40 to 90 wt. %, 5 to 80 wt. %, 10 to 80 wt. %, 20 to 80 wt. %, 30 to 80 wt. %, 5 to 75 wt. %, 10 to 75 wt. %, 20 to 75 wt. %, 30 to 75 wt. %, 10 to 70 wt. %, 20 to 70 wt. %, 30 to 70 wt. %, or 35 to 75 wt. %.

The overall composition of the polymerizable material(s) is often selected so that the polymerized component(s) is soluble in a solvent medium. Homogeneity of the organic phase is often preferable to avoid phase separation of the organic component in the gel composition. This tends to result in the formation of smaller and more homogeneous pores (pores with a narrower size distribution) in the subsequently formed aerogel or xerogel. Further, the overall composition of the polymerizable material can be selected to adjust compatibility with a solvent medium and to adjust the strength, flexibility, and uniformity of the gel composition. Still further, the overall composition of the polymerizable component(s) can be selected to adjust the burnout characteristics of the organic material prior to sintering.

In some embodiments, the optional second monomer is a polar monomer. As used herein, the term “polar monomer” refers to a monomer having a free radical polymerizable group and a polar group. The polar group is typically non-acidic and often contains a hydroxyl group, a primary amido group, a secondary amido group, a tertiary amido group, an amino group, or an ether group (i.e., a group containing at least one alkylene-oxy-alkylene group of formula —R—O—R— where each R is an alkylene having 1 to 4 carbon atoms).

Suitable optional polar monomers having a hydroxyl group include, but are not limited to, hydroxyalkyl (meth)acrylates (e.g., 2-hydroxyethyl (meth)acrylate, 2-hydroxypropyl (meth)acrylate, 3-hydroxypropyl (meth)acrylate, and 4-hydroxybutyl (meth)acrylate), hydroxyalkyl (meth)acrylamides (e.g., 2-hydroxyethyl (meth)acrylamide or 3-hydroxypropyl (meth)acrylamide), ethoxylated hydroxyethyl (meth)acrylates (e.g., monomers commercially available from Sartomer under the trade designation CD570, CD571, and CD572), and aryloxy substituted hydroxyalkyl (meth)acrylates (e.g., 2-hydroxy-2-phenoxypropyl (meth)acrylate).

Exemplary polar monomers with a primary amido group include (meth)acrylamide. Exemplary polar monomers with secondary amido groups include, but are not limited to, N-alkyl (meth)acrylamides such as N-methyl (meth)acrylamide, N-ethyl (meth)acrylamide, N-isopropyl (meth)acrylamide, N-tert-octyl (meth)acrylamide, and N-octyl (meth)acrylamide. Exemplary polar monomers with a tertiary amido group include, but are not limited to, N-vinyl caprolactam, N-vinyl-2-pyrrolidone, (meth)acryloyl morpholine, and N,N-dialkyl (meth)acrylamides such as N,N-dimethyl (meth)acrylamide, N,N-diethyl (meth)acrylamide, N,N-dipropyl (meth)acrylamide, and N,N-dibutyl (meth)acrylamide.

Polar monomers with an amino group include various N,N-dialkylaminoalkyl (meth)acrylates and N,N-dialkylaminoalkyl (meth)acrylamides. Examples include, but are not limited to, N,N-dimethyl aminoethyl (meth)acrylate, N,N-dimethylaminoethyl (meth)acrylamide, N,N-dimethylaminopropyl (meth)acrylate, N,N-dimethylaminopropyl (meth)acrylamide, N,N-diethylaminoethyl (meth)acrylate, N,N-diethylaminoethyl (meth)acrylamide, N,N-diethylaminopropyl (meth)acrylate, and N,N-diethylaminopropyl (meth)acrylamide.

Exemplary polar monomers with an ether group include, but are not limited to, alkoxylated alkyl (meth)acrylates such as ethoxyethoxyethyl (meth)acrylate, 2-methoxyethyl (meth)acrylate, and 2-ethoxyethyl (meth)acrylate; and poly(alkylene oxide) (meth)acrylates such as poly(ethylene oxide) (meth)acrylates and poly(propylene oxide) (meth)acrylates. The poly(alkylene oxide) acrylates are often referred to as poly(alkylene glycol) (meth)acrylates. These monomers can have any suitable end group such as a hydroxyl group or an alkoxy group. For example, when the end group is a methoxy group, the monomer can be referred to as methoxy poly(ethylene glycol) (meth)acrylate.

Suitable alkyl (meth)acrylates that can be used as a second monomer can have an alkyl group with a linear, branched, or cyclic structure. Examples of suitable alkyl (meth)acrylates include, but are not limited to, methyl (meth)acrylate, ethyl (meth)acrylate, n-propyl (meth)acrylate, isopropyl (meth)acrylate, n-butyl (meth)acrylate, isobutyl (meth)acrylate, n-pentyl (meth)acrylate, 2-methylbutyl (meth)acrylate, n-hexyl (meth)acrylate, cyclohexyl (meth)acrylate, 4-methyl-2-pentyl (meth)acrylate, 2-ethylhexyl (meth)acrylate, 2-methylhexyl (meth)acrylate, n-octyl (meth)acrylate, isooctyl (meth)acrylate, 2-octyl (meth)acrylate, isononyl (meth)acrylate, isoamyl (meth)acrylate, 3,3,5-trimethylcyclohexyl (meth)acrylate, n-decyl (meth)acrylate, isodecyl (meth)acrylate, isobornyl (meth)acrylate, 2-propylheptyl (meth)acrylate, isotridecyl (meth)acrylate, isostearyl (meth)acrylate, octadecyl (meth)acrylate, 2-octyldecyl (meth)acrylate, dodecyl (meth)acrylate, lauryl (meth)acrylate, and heptadecanyl (meth)acrylate. In some embodiments, the alkyl (meth)acrylates are a mixture of various isomers having the same number of carbon atoms as described in PCT Patent Application Publication WO 2014/151179 (Colby et al.). For example, an isomer mixture of octyl (meth)acrylate can be used.

The amount of a second monomer that is a polar monomer and/or an alkyl (meth)acrylate monomer is often in a range of 0 to 60 wt. %, 0 to 55 wt. %, 0 to 50 wt. %, 2 to 60 wt. %, 2 to 55 wt. %, 2 to 50 wt. %, 5 to 60 wt. %, 5 to 55 wt. %, 5 to 50 wt. %, or 5 to 45 wt. % based on a total weight of the polymerizable component.

The total amount of polymerizable component is often at least 2 wt. %, at least 3 wt. %, at least 4 wt. %, or at least 5 wt. % based on the total weight of the sol. The amount of polymerizable component can be up to 50 wt. %, up to 40 wt. %, up to 35 wt. %, up to 30 wt. %, or up to 25 wt. %, based on the total weight of the sol. For example, the amount of polymerizable component can be in a range of 2 to 50 wt. %, 2 to 40 wt. %, 2 to 30 wt. %, 3 to 50 wt. %, 3 to 40 wt. %, 3 to 30 wt. %, 5 to 50 wt. %, 5 to 40 wt. %, 5 to 30 wt. %, or 5 to 25 wt. % based on the total weight of the sol.

In some embodiments, the polymerizable material contains 10 to 100 wt. % first monomer (i.e., surface modifying agent) and 0 to 90 wt. % second monomer based on a total weight of the polymerizable component. For example, the polymerizable component may include 10 to 90 wt. % first monomer and 10 to 90 wt. % second monomer, 10 to 80 wt. % first monomer and 20 to 90 wt. % second monomer, 10 to 70 wt. % first monomer and 30 to 90 wt. % second monomer, 12 to 100 wt. % first monomer and 0 to 88 wt. % second monomer, 12 to 90 wt. % first monomer and 10 to 88 wt. % second monomer, 12 to 80 wt. % first monomer and 20 to 88 wt. % second monomer, 12 to 70 wt. % first monomer and 30 to 88 wt. % second monomer, 15 to 100 wt. % first monomer and 0 to 85 wt. % second monomer, 15 to 90 wt. % first monomer and 10 to 85 wt. % second monomer, 15 to 80 wt. % first monomer and 20 to 85 wt. % second monomer, 15 to 70 wt. % first monomer and 30 to 85 wt. % second monomer, 20 to 80 wt. % first monomer and 20 to 80 wt. % second monomer, or 20 to 70 wt. % first monomer and 30 to 80 wt. % second monomer.

In some embodiments, the polymerizable component contains 0 wt. % first monomer and 100 wt. % second monomer based on a total weight of the polymerizable component.

### Optional Components

### Surfactant

In some embodiments, the sol further comprises at least one surfactant. Suitable surfactants may comprise cationic surfactant(s), non-ionic surfactant(s), anionic surfactant(s), or combinations thereof.

Suitable anionic surfactants include, but are not limited to, those with molecular structures comprising (1) at least one hydrophobic moiety, such as from about C6 to about C20 alkyl, alkylaryl, and/or alkenyl groups, (2) at least one anionic group, such as sulfate, sulfonate, phosphate, polyoxyethylene sulfate, polyoxyethylene sulfonate, polyoxyethylene phosphate, and the like, and/or (3) the salts of such anionic groups, wherein the salts include alkali metal salts, ammonium salts, tertiary amino salts, and the like. For instance, sodium dodecyl sulfate. A representative commercial example of a useful anionic surfactant includes sodium lauryl sulfate, available under the trade name TEXAPON L-100 from Henkel Inc. (Wilmington, DE). Suitable neutral surfactants include polyethoxylated alkyl alcohols such as Surfynol SE-F, available from Air Products and Chemicals Inc. (Allentown, PA). Suitable cationic surfactants include cetyltrimethylammonium bromide, available from Sigma Aldrich (St. Louis, MO).

### Photoinitiator

Optionally, the sol further comprises one or more photoinitiators. In certain embodiments, the photoinitiator(s) can be characterized by being soluble in a solvent contained in the sol and/or absorbing radiation within a range from 200 to 500 nm or from 300 to 450 nm. The photoinitiator should be able to start or initiate the curing or hardening reaction of the polymerizable component(s) being present in the sol.

The following classes of photoinitiator(s) can be used: a) two-component system where a radical is generated through abstraction of a hydrogen atom from a donor compound; b) one component system where two radicals are generated by cleavage; and/or c) a system comprising an iodonium salt, a visible light sensitizer, and an electron donor compound.

Examples of photoinitiators according to type (a) typically contain a moiety selected from benzophenone, xanthone or quinone in combination with an aliphatic amine.

Examples of photoinitiators according to type (b) typically contain a moiety selected form benzoin ether, acetophenone, benzoyl oxime or acyl phosphine. Suitable exemplary photoinitiators are those available under the trade designation OMNIRAD from IGM Resins (Waalwijk, The Netherlands) and include 1-hydroxycyclohexyl phenyl ketone (OMNIRAD 184), 2,2-dimethoxy-1,2-diphenylethan-1-one (OMNIRAD 651), bis(2,4,6 trimethylbenzoyl)phenylphosphineoxide (OMNIRAD 819), 1-[4-(2-hydroxyethoxy)phenyl]-2-hydroxy-2-methyl-1-propane-1-one (OMNIRAD 2959), 2-benzyl-2-dimethylamino-1-(4-morpholinophenyl)butanone (OMNIRAD 369), 2-methyl-1-[4-(methylthio)phenyl]-2-morpholinopropan-1-one (OMNIRAD 907), 2-hydroxy-2-methyl-1-phenyl propan-1-one (OMNIRAD 1173), 2,4,6-trimethylbenzoyldiphenylphosphine oxide (OMNIRAD TPO), and 2,4,6-trimethylbenzoylphenyl phosphinate (OMNIRAD TPO-L). Additional suitable photoinitiators include for example and without limitation, Oligo[2-hydroxy-2-methyl-1-[4-(1-methylvinyl)phenyl]propanone] ESACURE ONE (Lamberti S.p.A., Gallarate, Italy), 2-hydroxy-2-methylpropiophenone, benzyl dimethyl ketal, 2-methyl-2-hydroxypropiophenone, benzoin methyl ether, benzoin isopropyl ether, anisoin methyl ether, aromatic sulfonyl chlorides, photoactive oximes, and combinations thereof.

Examples of photoinitiators according to type (c) typically contain the following moieties for each component. Suitable iodonium salts are described in U.S. Pat. Nos. 3,729,313, 3,741,769, 3,808,006, 4,250,053 and 4,394,403, the iodonium salt disclosures of which are incorporated herein by reference. The iodonium salt can be a simple salt, containing an anion such as Cl⁻, Br⁻, I⁻ or C₄HsSO₃⁻; or a metal complex salt containing an antimonate, arsenate, phosphate or borate such as SbF₅OH⁻ or AsF₆⁻. Mixtures of iodonium salts can be used if desired. For instance, suitable iodonium salts include each of diphenyliodonium hexafluorophosphate and diphenyliodonium chloride, both commercially available from Sigma-Aldrich (St. Louis, MO). The visible light sensitizer may be selected from ketones, coumarin dyes (e.g., ketocoumarins), xanthene dyes, acridine dyes, thiazole dyes, thiazine dyes, oxazine dyes, azine dyes, aminoketone dyes, porphyrins, aromatic polycyclic hydrocarbons, p-substituted aminostyryl ketone compounds, aminotriaryl methanes, merocyanines, squarylium dyes and pyridinium dyes. Preferably, the visible light sensitizer is an alpha-diketone; camphorquinone is particularly preferred and commercially available from Sigma-Aldrich. The electron donor compound is typically an alkyl aromatic polyether or an alkyl, aryl amino compound wherein the aryl group is substituted by one or more electron withdrawing groups. Examples of suitable electron withdrawing groups include carboxylic acid, carboxylic acid ester, ketone, aldehyde, sulfonic acid, sulfonate and nitrile groups.

The electron donor compound may be selected from polycylic aromatic compounds (such as biphenylenes, naphthalenes, anthracenes, benzanthracenes, pyrenes, azulenes, pentacenes, decacyclenes, and derivatives (e.g., acenaphthenes) and combinations thereof), and N-alkyl carbazole compounds (e.g., N-methyl carbazole). Preferred donor compounds include 4-dimethylaminobenzoic acid, ethyl 4-dimethylaminobenzoate, 3-dimethylaminobenzoic acid, 4-dimethylaminobenzoin, 4-dimethylaminobenzaldehyde, 4-dimethylaminobenzonitrile and 1,2,4-trimethoxybenzene. Photoinitiators according to type (c) are described in detail, for instance, in co-owned U.S. Pat. No. 6,187,833 (Oxman et al.).

A photoinitiator can be present in a sol described herein, in some embodiments, in an amount of 0.005 wt. % or more, 0.01 wt. % or more, 0.05 wt. % or more, 0.1 wt. % or more, or 0.3 wt. % or more; and 5 wt. % or less, 4 wt. % or less, 3 wt. % or less, 2 wt. % or less, 1 wt. % or less, or 0.5 wt. % or less, based on the total weight of the sol. In some cases, a photoinitiator is present in an amount of about 0.005-5 wt. %, or 0.1-2 wt. %, based on the total weight of the sol.

In addition, a sol described herein can further comprise one or more sensitizers to increase the effectiveness of one or more photoinitiators that may also be present. In some embodiments, a sensitizer comprises isopropylthioxanthone (ITX) or 2-chlorothioxanthone (CTX). Other sensitizers may also be used. If used in the sol, a sensitizer can be present in an amount of about 0.0010% by weight or more, 0.010% by weight or more, or about 1% by weight or more, based on the total weight of the sol.

### EMBODIMENTS

In a first embodiment, the present disclosure provides a method of making a three-dimensional article. The method includes: a) inkjetting a sol through a nozzle having a diameter of 10 micrometers to 70 micrometers to form a plurality of droplets of printed sol; b) solidifying the printed sol to form a portion of the three-dimensional article; and c) repeating steps a) and b) to form the three-dimensional article having a specified geometry. The sol includes: i) 5 percent by volume (vol. %) to 40 vol. % of metal oxide particles, based on the total volume of the sol, the metal oxide particles having an average particle size of 20 nanometers (nm) or less and of 1/100 to 1/10,000 of a diameter of the nozzle; ii) a solvent; iii) a surface modifying agent; and iv) optionally a polymerizable component.

In a second embodiment, the present disclosure provides a method according to the first embodiment, wherein the sol exits the nozzle as a plurality of uncured droplets each having a volume of 4 picoliters to 200 picoliters.

In a third embodiment, the present disclosure provides a method according to the first embodiment or the second embodiment, wherein the metal oxide particles have an average diameter of 1 nm or greater, 2 nm, 4 nm, 5 nm, 6 nm, 8 nm, 10 nm, 12 nm, 14 nm, 15 nm, 16 nm, or 18 nm or greater; and 45 nm or less, 42 nm, 40 nm, 37 nm, 35 nm, 32 nm, 30 nm, 27 nm, 25 nm, 22 nm, or 20 nm or less, preferably 6 nm or greater and 20 nm or less.

In a fourth embodiment, the present disclosure provides a method according to any of the first through third embodiments, wherein the sol exits the nozzle at a drop rate of up to 20,000 Hz.

In a fifth embodiment, the present disclosure provides a method according to any of the first through fourth embodiments, wherein the sol further comprises one or more elements selected from the group consisting of Mn, Fe, Cu, Pr, Nd, Sm, Eu, Tb, Dy, Er, Cr, Co, Ni, Al, Ti, V, Ta, Y, Ce, Mg, Ca, La, Sc, and Bi, wherein the one or more elements are provided within at least one plurality of particles.

In a sixth embodiment, the present disclosure provides a method according to the fifth embodiment, wherein one or more elements are provided as one or more additional elements within the metal oxide particles.

In a seventh embodiment, the present disclosure provides a method according to the fifth embodiment or the sixth embodiment, wherein the one or more elements comprise Y, Ce, Ca, Mg, Sc, and/or La.

In an eighth embodiment, the present disclosure provides a method according to any of the fifth through seventh embodiments, wherein the sol is a first sol and the method further comprises inkjetting through a nozzle having a diameter of 10 micrometers to 70 micrometers a droplet of a second sol onto a solidified printed droplet of the first sol, wherein the first sol and the second sol do not have the same composition.

In a ninth embodiment, the present disclosure provides a method according to any of the fifth through eighth embodiments, further comprising: prior to step a), retrieving, from a non-transitory machine readable medium, data representing a 3D model of the three-dimensional article; and executing, by one or more processors, a 3D printing application interfacing with an inkjet printer using the data to generate, by the inkjet printer, a physical object of the three-dimensional article.

In an tenth embodiment, the present disclosure provides a method according to any of the fifth through eighth embodiments, further comprising: prior to step a), receiving, by a manufacturing device having one or more processors, a digital object comprising data specifying the three-dimensional article; and generating, with the manufacturing device by an additive manufacturing process, the three-dimensional article based on the digital object.

In an eleventh embodiment, the present disclosure provides a method according to the ninth embodiment or the tenth embodiment, wherein the data comprises information that maps out two or more different optical properties located across a geometry of the digital object.

In a twelfth embodiment, the present disclosure provides a method according to the eleventh embodiment, wherein the two or more different optical properties are selected from the group consisting of color, translucency, and fluorescence.

In a thirteenth embodiment, the present disclosure provides a method according to the eleventh embodiment or the twelfth embodiment, further comprising, prior to step a), performing a scan of an object and processing the scan to provide optical property data comprising the information of the two or more different optical properties.

In a fourteenth embodiment, the present disclosure provides a method according to the thirteenth embodiment, further comprising modifying the information based on feedback from a human being.

In a fifteenth embodiment, the present disclosure provides a method according to any of the first through fourteenth embodiments, wherein the solvent comprises one or more of water or an alcohol.

In a sixteenth embodiment, the present disclosure provides a method according to the fifteenth embodiment, wherein the solvent comprises one or more alcohols selected from the group consisting of C2 to C8 mono alcohols, C2 to C8 poly alcohols, or C2 to C8 alkoxylated alcohols, preferably ethanol, propanol, methanol, ethylene glycol, propylene glycol, glycerine, diethylene glycol ethyl ether, or 1-methoxy-2-propanol.

In a seventeenth embodiment, the present disclosure provides a method according to any of the first through sixteenth embodiments, wherein the surface modifying agent comprises a compound of Formula (IV): H₃CO—[(CH₂)_{y}O]_{z}-Q-COOH (IV), wherein Q is a divalent organic linking group, z is an integer in the range of 1 to 10, and y is an integer in the range of 1 to 4.

In an eighteenth embodiment, the present disclosure provides a method according to any of the first through seventeenth embodiments, wherein the surface modifying agent comprises 2-[2-(2-methoxyethoxy)ethoxy]acetic acid (“MEEAA”) and the solvent comprises diethylene glycol ethyl ether.

In a nineteenth embodiment, the present disclosure provides a method according to any of the first through eighteenth embodiments, wherein the surface modifying agent comprises a compound of Formula (V): X—COOH (V), wherein X is miscible with the solvent.

In a twentieth embodiment, the present disclosure provides a method according to any of the first through nineteenth embodiments, wherein the surface modifying agent comprises a compound comprising a silane.

In a twenty-first embodiment, the present disclosure provides a method according to any of the first through twentieth embodiments, wherein the surface modifying agent is present in an amount of 0.5 wt. % or greater, based on the total weight of the metal oxide particles, to 25 wt. % or less, based on the total weight of the metal oxide particles.

In a twenty-second embodiment, the present disclosure provides a method according to any of the first through twenty-first embodiments, wherein the sol further comprises at least one surfactant.

In a twenty-third embodiment, the present disclosure provides a method according to any of the first through twenty-second embodiments, wherein the metal oxide particles are present in an amount of 6 vol. % or greater, based on the total volume of the sol, 7 vol. %, 8 vol. %, 9 vol. %, or 10 vol. % or greater; and 40 vol. % or less, based on the total volume of the sol, 38 vol. %, 35 vol. %, 32 vol. %, 30 vol. %, 28 vol. %, 25 vol. %, 22 vol. %, 20 vol. %, 18 vol. %, or 16 vol. % or less.

In a twenty-fourth embodiment, the present disclosure provides a method according to any of the first through twenty-third embodiments, wherein each of the plurality of uncured droplets has a volume in a range of 5 picoliters or greater, 6 picoliters, 7 picoliters, 8 picoliters, 9 picoliters, 10 picoliters, 12 picoliters, 15 picoliters, 20 picoliters, 25 picoliters, 30 picoliters, 35 picoliters, 40 picoliters, 45 picoliters, or 50 picoliters or greater; and 200 picoliters or less, 190 picoliters, 180 picoliters, 170 picoliters, 160 picoliters, 150 picoliters, 140 picoliters, 130 picoliters, 120 picoliters, 110 picoliters, 100 picoliters, 95 picoliters, 90 picoliters, 85 picoliters, 80 picoliters, 75 picoliters, 70 picoliters, 65 picoliters, 60 picoliters, or 55 picoliters or less.

In a twenty-fifth embodiment, the present disclosure provides a method according to any of the first through twenty-fourth embodiments, wherein the sol has a dynamic viscosity of 2 milliPascal seconds (mPa·s) to 150 mPa·s at 23° C. and a shear rate of 10000 s⁻¹.

In a twenty-sixth embodiment, the present disclosure provides a method according to any of the first through twenty-fifth embodiments, wherein the polymerizable component comprises one or more curable monomers or oligomers.

In a twenty-seventh embodiment, the present disclosure provides a method according to any of the first through twenty-sixth embodiments, wherein a portion of the droplets of the sol are printed on a support material.

In a twenty-eighth embodiment, the present disclosure provides a method according to any of the first through twenty-seventh embodiments, wherein the inkjet printing is performed in an inert atmosphere.

In a twenty-ninth embodiment, the present disclosure provides a method according to any of the first through twenty-eighth embodiments, wherein the inkjet printing is performed in a closed system.

In a thirtieth embodiment, the present disclosure provides a method according to any of the first through twenty-eighth embodiments, wherein the inkjet printing is performed in an open system and wherein the method further comprises controlling a gas phase region of the system.

In a thirty-first embodiment, the present disclosure provides a method according to any of the first through thirtieth embodiments, wherein the solidifying comprises drying the printed sol.

In a thirty-second embodiment, the present disclosure provides a method according to any of the first through thirty-first embodiments the method further comprising subjecting the three-dimensional article to actinic radiation, heat, and/or a vapor that adjusts a pH of the three-dimensional article.

In a thirty-third embodiment, the present disclosure provides a method according to any of the first through thirty-second embodiments, wherein the three-dimensional article comprises an area of an exterior surface of 300 to 3,000 square micrometers comprising three different optical properties.

In a thirty-fourth embodiment, the present disclosure provides a method according to any of the first through thirty-third embodiments, wherein the three-dimensional article comprises an area of an exterior surface of 300 to 3,000 square micrometers comprising three different colors.

In a thirty-fifth embodiment, the present disclosure provides a method according to any of the first through thirty-second embodiments, wherein the three-dimensional article comprises an area of an exterior surface of 300 to 3,000 square micrometers comprising three different mechanical properties.

In a thirty-sixth embodiment, the present disclosure provides a method according to any of the first through thirty-second embodiments, wherein the sol has a surface tension of 0.02 Joules per square meter (J/m²) to 0.08 J/m².

In a thirty-seventh embodiment, the present disclosure provides a method according to any of the first through thirty-sixth embodiments, wherein the sol is a first sol and the method further comprises inkjetting through a nozzle having a diameter of 10 micrometers to 70 micrometers a droplet of a second sol onto a solidified printed droplet of the first sol, wherein the first sol and the second sol have different surface tensions.

In a thirty-eighth embodiment, the present disclosure provides a method according to any of the first through thirty-seventh embodiments, wherein the three-dimensional article has a specified optical appearance.

In a thirty-ninth embodiment, the present disclosure provides a method according to any of the first through thirty-eighth embodiments, wherein the three-dimensional article has one or more specified mechanical properties.

In a fortieth embodiment, the present disclosure provides a method according to any of the first through thirty-ninth embodiments, further comprising: extracting solvent from the three-dimensional article to form an aerogel article or a xerogel article; heat treating the aerogel article or the xerogel article to form a porous ceramic article; and sintering the porous ceramic article to form a sintered ceramic article.

In a forty-first embodiment, the present disclosure provides a method according to the fortieth embodiment, wherein the sintered ceramic article comprises a volume of 0.6 to 500 picoliters comprising three different optical properties.

In a forty-second embodiment, the present disclosure provides a method according to the forty-first embodiment, wherein the optical properties comprise color.

In a forty-third embodiment, the present disclosure provides a method according to any of the fortieth through forty-second embodiments, wherein the sintered ceramic article comprises a volume of 0.6 to 500 picoliters comprising three different mechanical properties.

In a forty-fourth embodiment, the present disclosure provides a method according to any of the first through forty-third embodiments, wherein the metal oxide particles comprise zirconia.

In a forty-fifth embodiment, the present disclosure provides a method according to any of the first through forty-fourth embodiments, wherein the metal oxide particles comprise silica.

### EXAMPLES

Unless otherwise noted or apparent from the context, all parts, percentages, ratios, etc. in the Examples and the rest of the specification are by weight.

### Preparative Example 1 (Sol Synthesis

Sol compositions are reported in mole percent inorganic oxide. The following hydrothermal reactor was used for preparing the sol. The hydrothermal reactor was prepared from 15 meters of stainless steel braided smooth tube hose (0.64 cm inside diameter, 0.17 cm thick wall; obtained under the trade designation “DuPont T62 CHEMFLUOR PTFE” from Saint-Gobain Performance Plastics, Beaverton, MI). This tube was immersed in a bath of peanut oil heated to the desired temperature. Following the reactor tube, a coil of an additional 3 m of the same stainless steel braided smooth tube hose plus 3 m of 0.64 cm stainless-steel tubing with a diameter of 0.64 cm and wall thickness of 0.089 cm was immersed in an ice-water bath to cool the material and a backpressure regulator valve was used to maintain an exit pressure of 3.45 MPa.

A precursor solution was prepared by combining 2,000 g zirconium acetate solution with 1,889.92 g deionized water. 112.2 g yttrium acetate were added while mixing until fully dissolved. The solids content of the resulting solution was measured gravimetrically (120° C./hr. forced air oven) to be 19.31 wt. %. 65.28 g deionized water were added to adjust the final concentration to 19 wt. %. The resulting solution was pumped at a rate of 11.48 mL/min. through the hydrothermal reactor. The temperature was 225° C. and the average residence time was 42 minutes. A clear and stable zirconia sol was obtained.

The resulting sol was concentrated (35-45 wt. % solids) via ultrafiltration using a membrane cartridge (obtained under the trade designation “M21S-100-01P” from Spectrum Laboratories Inc., Rancho Dominguez, CA). As medium for the filtration process ethanol was used. With that, next to increasing the solid content of the sol, a partial exchange of water with ethanol was achieved.

The size of the obtained zirconia particles was in the range of 15 to 25 nm according to light scattering measurement (Z-average).

### Preparative Example 2 (Ethanol/Water Solvent

4.5 wt. % acrylic acid, 2.3 wt. % N-hydroxyethyl acrylamide (HEAA), and 0.08 wt. % photoinitiator (Irgacure 819) were added to the sol.

TABLE 1
Final composition of printing sol preparation
containing ethanol and water.

| Material | Amount; wt. % |
|---|---|
| Oxides (96:4 ZrO₂:Y₂O₃ mole ratio) | 42.4 |
| Acetic acid | 5.6 |
| Ethanol | 25.72 |
| Water | 19.4 |
| Acrylic acid | 4.5 |
| N-Hydroxyethyl acrylamide | 2.3 |
| IRGACURE 819 | 0.08 |

### Preparative Example 3 (Diethylene Glycol Ethyl Ether Solvent

A diethylene glycol ethyl ether based sol was produced by adding the appropriate amount of diethylene glycol ethyl ether (adjusted to the intended final concentration of zirconia in the sol, i.e., 50 wt. %) to the ethanolic sol and afterwards ethanol and water were removed by gentle heating under reduced pressure. Additionally, 1.5 wt. % 2,2,2-MEEAA (2-[2-(2-methoxyethoxy) ethoxy]acetic acid) was added for adjusting the viscosity.

4.3 wt. % acrylic acid, 2.2 wt. % N-hydroxyethyl acrylamide (HEAA), 0.08 wt. % photoinitiator (IRGACURE 819), 0.02 wt. % dye (isatin: 1H-indole-2,3-dione) and 0.02 wt. % inhibitor (MOP: 4-methoxyphenol) were added to the sol.

TABLE 2
Final composition of printing sol preparation
containing diethylene glycol ethyl ether.

| Material | Amount; wt. % |
|---|---|
| Oxides (96:4 ZrO₂:Y₂O₃ mole ratio) | 50.0 |
| Acetic acid | 2.4 |
| Diethylene glycol ethyl ether | 38.48 |
| Water | 1 |
| Acrylic acid | 4.3 |
| N-Hydroxyethyl acrylamide | 2.2 |
| IRGACURE 819 | 0.08 |
| 2-[2-(2-methoxyethoxy)ethoxy]acetic acid | 1.5 |
| Isatin | 0.02 |
| 4-methoxyphenol (MOP) | 0.02 |

### Physical Analysis of the Sol:

Density: 1.4 g/cm³

Viscosity: 0.024 Pa·s

Particle size: 15-25 nm (Z-average, determined by dynamic light scattering)

### Example 1

### Inkjet Printing of Sol of Preparative Example 2

The inkjet printing experiments have been realized with Voxeljet 3D Inkjet Printing Test Setup “Tests and Drop Observation” (Voxeljet AG, Friedberg, Germany).

A printjob file containing files with the printing structure was generated with Netfabb 4 Professional (Netfabb, Lupburg, Germany). The png file was loaded in the Voxeljet VTS 16 Software. Parameters for printing were as follows: Temperature: 0 (heater disabled, using room temperature of 23° C.); Pulseform: 11 μs (waveform to control printhead); Resolution: 150 μm (used machine resolution parameter to determine the relative distance between nozzles; the nozzle diameter is an independent parameter defined by the printhead).

As substrate, a glass microscope slide was used.

As inkjet printheads, Fujitsu Dimatix Spectra SL128 printheads were installed. The fluid system was filled with ethylene glycol as purging agent. The printhead was purged with ethylene glycol until no blue color appeared anymore (the storage liquid of Dimatix printheads was purged out before using). Afterwards, the ethylene glycol was removed from the fluid system and replaced with the printing sol formulation shown in Preparative Example 2. The printhead was purged with the sol formulation and the printing was started right after purging to prevent clogging due to evaporation of the ethanol. Right after the printing process, the printhead was purged with ethylene glycol again.

The printing experiment resulted in a successful application of material droplets on the glass slide showing the printability of the described printing sol formulation. The printed structure matched with the input file. Referring to FIG. 8, a photograph is provided of the three-dimensional article according to Example 1. The article 800 forms the word “prints” from inkjet-printed sol droplets. For instance, a single printed droplet 810 forms the dot of the letter “i”, while a plurality of sol droplets 820 were used to collectively form the letter “t”.

All cited references, patents, and patent applications in the above application for letters patent are herein incorporated by reference in their entirety in a consistent manner. In the event of inconsistencies or contradictions between portions of the incorporated references and this application, the information in the preceding description shall control. The preceding description, given in order to enable one of ordinary skill in the art to practice the claimed disclosure, is not to be construed as limiting the scope of the disclosure, which is defined by the claims and all equivalents thereto.

1. A method of making a three-dimensional article comprising:
a) inkjetting a sol through a nozzle having a diameter of 10 micrometers to 70 micrometers to form a plurality of droplets of printed sol, wherein the sol comprises:
i) 5 percent by volume (vol. %) to 40 vol. % of metal oxide particles, based on the total volume of the sol, the metal oxide particles having an average particle size of 20 nanometers (nm) or less and of 1/100 to 1/10,000 of a diameter of the nozzle;
ii) a solvent;
iii) a surface modifying agent; and
iv) optionally a polymerizable component;
b) solidifying the printed sol to form a portion of the three-dimensional article; and
c) repeating steps a) and b) to form the three-dimensional article having a specified geometry.

2. The method of claim 1, wherein the sol exits the nozzle as a plurality of uncured droplets each having a volume of 4 picoliters to 200 picoliters.

3. The method of claim 1, wherein the sol further comprises one or more elements selected from the group consisting of Mn, Fe, Cu, Pr, Nd, Sm, Eu, Tb, Dy, Er, Cr, Co, Ni, Al, Ti, V, Ta, Y, Ce, Mg, Ca, La, Sc, and Bi, wherein the one or more elements are provided within at least one plurality of particles.

4. The method of claim 3, wherein the sol is a first sol and the method further comprises inkjetting through a nozzle having a diameter of 10 micrometers to 70 micrometers a droplet of a second sol onto a solidified printed droplet of the first sol, wherein the first sol and the second sol do not have the same composition.

5. The method of claim 3, further comprising prior to step a), retrieving, from a non-transitory machine readable medium, data representing a 3D model of the three-dimensional article; and executing, by one or more processors, a 3D printing application interfacing with an inkjet printer using the data to generate, by the inkjet printer, a physical object of the three-dimensional article.

6. The method of claim 3, further comprising, prior to step a), receiving, by a manufacturing device having one or more processors, a digital object comprising data specifying the three-dimensional article; and generating, with the manufacturing device by an additive manufacturing process, the three-dimensional article based on the digital object.

7. The method of claim 5, wherein the data comprises information that maps out two or more different optical properties located across a geometry of the digital object.

8. The method of claim 7, further comprising, prior to step a), performing a scan of an object and processing the scan to provide optical property data comprising the information of the two or more different optical properties.

9. The method of claim 8, further comprising modifying the information based on feedback from a human being.

10. The method of claim 1, wherein the sol further comprises at least one surfactant.

11. The method of claim 1, wherein a portion of the droplets of the sol are printed on a support material.

12. The method of claim 1, wherein the inkjet printing is performed in a closed system.

13. The method of claim 1, wherein the inkjet printing is performed in an open system and wherein the method further comprises controlling a gas phase region of the system.

14. The method of claim 1, further comprising subjecting the three-dimensional article to actinic radiation, heat, and/or a vapor that adjusts a pH of the three-dimensional article.

15. The method of claim 1, wherein the sol has a surface tension of 0.02 Joules per square meters (J/m²) to 0.08 J/m².

16. The method of claim 1, wherein the sol is a first sol and the method further comprises inkjetting through a nozzle having a diameter of 10 micrometers to 70 micrometers a droplet of a second sol onto a solidified printed droplet of the first sol, wherein the first sol and the second sol have different surface tensions.

17. The method of claim 1, further comprising extracting solvent from the three-dimensional article to form an aerogel article or a xerogel article; heat treating the aerogel article or the xerogel article to form a porous ceramic article; and sintering the porous ceramic article to form a sintered ceramic article.

18. The method of claim 17, wherein the sintered ceramic article comprises a volume of 0.6 to 500 picoliters comprising three different optical properties, three different mechanical properties, or both.

19. The method of claim 1, wherein the metal oxide particles comprise zirconia, silica, or both.
